(19) United States
(12) Patent Application Publication
(10) Pub. No.: US 2010/0019212 A1
(43) Pub. Date: Jan. 28, 2010

(54) NEAR INFRARED RAY-ABSORBABLE DYE COMPOSITION, AND NEAR INFRARED RAY-ABSORBABLE FILTER AND ADHESIVE AGENT BOTH COMPRISING THE COMPOSITION

(75) Inventors: Masataka Yamamoto, Fukuoka (JP); Takeshi Yamanaka, Fukuoka (JP); Wataru Sato, Kanagawa (JP); Yasuyo Saito, Kanagawa (JP); Kumiko Okamoto, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: API CORPORATION, Osaka-shi (JP)

(21) Appl. No.: 12/447,087

(22) PCT Filed: Oct. 22, 2007
(86) PCT No.: PCT/JP07/70568

§ 371 Date: Apr. 24, 2009

(30) Foreign Application Priority Data
Oct. 27, 2006 (JP) 2006-292716

(51) Int. Cl. F21V 9/04

(52) U.S. Cl. 252/587

(57) ABSTRACT

It is an object to provide a near infrared light absorbable dye composition which absorbs near infrared light efficiently, has a high visible light transmittance, is excellent in light resistance, heat resistance and wet heat resistance, is hardly deteriorated in durability even when blended so as to have an absorption in a wide range of 800 to 1100 nm, and requires a low cost for synthesis and isolation thereof upon production, and provide a near infrared light absorbable filter containing the same. Provided is the near infrared light absorbable dye composition containing compounds represented by the following formulae (1), (2) and (3):

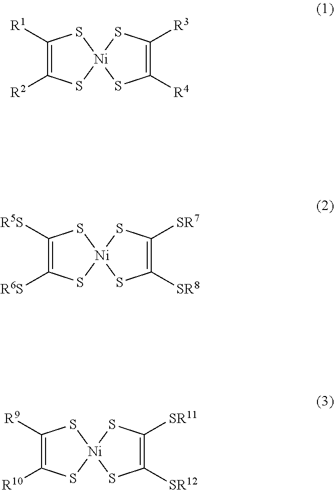

wherein R¹ to R⁴ represent an organic group which has a carbon atom at a binding position and may have a substituent or a hydrogen atom, R⁵ to R⁸ represent an aliphatic hydrocarbon group or an aryl group which may have a substituent, R¹ and R² and the like may together form a ring; R⁹ and R¹⁰ in the general formula (3) represent R¹ and R² or R³ and R⁴ in the general formula (1), and R¹¹ and R¹² in the general formula (3) represent R⁵ and R⁶ or R⁷ and R⁸ in the general formula (2), respectively.

### TECHNICAL FIELD

The present invention relates to a near infrared light absorbable dye composition, a near infrared light absorbable dye composition solution, and a near infrared light absorbable filter and an pressure sensitive adhesive both comprising the same, and particularly relates to a near infrared light absorbable filter which blocks a near infrared light in a wide range, a near infrared light absorbable dye which can be blended in an pressure sensitive adhesive for electronic displays and the pressure sensitive adhesive for the electronic displays containing the same.

### BACKGROUND ART

Generally, plastic near infrared light absorbable filters composed of a resin containing a near infrared light absorbable dye have been well-known, and uses thereof include sunglasses, glasses for welding, windows in buildings, automobiles, electric trains and airplanes, or optical reading apparatuses for reading information. Also recently, plasma display panels (hereinafter abbreviated as “PDP”) noticed as large thin wall-hanging televisions generate the near infrared light, which acts upon electronic instruments, such as cordless phones and video cartridge recorders using a near infrared light remote control, in a circumference to cause a malfunction. Thus, filters containing the near infrared light absorbable dye which absorbs the near infrared light at 800 to 1100 nm are required as the filter for PDP.

As the near infrared light absorbable filter as described above, various types such as those containing metal ion such as copper or iron, and those containing the near infrared light absorbable dyes such as nitroso compounds and metal complex salts thereof, cyanine-based compounds, squarylium-based compounds, dithiol-based metal complex compounds, aminothiophenol-based metal complex compounds, phthalocyanine compounds, naphthalocyanine compounds, triarylmethane-based compounds, immonium-based compounds, diimmonium-based compounds, naphthoquinone-based compounds, anthraquinone-based compounds, amino compounds and aminium salt-based compounds have been studied (e.g., see Patent Documents 1 and 2), but actually, only some of the limited dithiol-based metal complex compounds, phthalocyanine compounds and diimmonium-based compounds are used.

However, the immonium-based compound has a problem that when it is contained in a resin layer containing a complex compound dye or a no metal-containing compound dye, immonium is deteriorated to absorb the lights at around 400 to 450 nm and the layer become yellowish. The phthalocyanine compound and the naphthalocyanine compound also have the problem that flexibility of the use as an optical filter is reduced in terms of low visible light transmittance although they are highly durable and hardly become yellowish due to the deterioration.

That is, the conventional near infrared light absorbable filters using these dyes have the problems that when multiple types of the dyes are mixed in consideration of labor hour and cost upon production, yellowish change occurs in long term use and the visible light transmittance is low.

Meanwhile, it is impossible to cover the aforementioned range of 800 to 1100 nm by only one type of the above near infrared light absorbable dye, and typically the multiple dyes are combined and used. At that time, when the multiple dyes are mixed and contained in the same resin layer to make the filter, the mixed dyes sometimes interact mutually to deteriorate a performance compared with the case of using a single dye alone. Therefore, the layers containing the respective dyes are often stacked in actual products.

As types of usage, (a) transparent polymer films made by kneading the near infrared light absorbable dye in the resin, (b) polymer films made by dispersing and dissolving the near infrared light absorbable dye in a thick resin solution of the resin or a resin monomer/organic solvent and casting it, (c) those obtained by adding the dye to a resin binder and an organic dye solvent and coating it on the transparent polymer film and (d) pressure sensitive adhesives containing the near infrared light absorbable dye, and the like are conceivable.

Here, it is common to paste the multiple layers by the above methods (a) to (c) to produce the product. However, when the labor hour upon the production, the cost, the light transmittance and the like are considered, it is a fact that the more layers are stacked, resulting in increase of the cost and reduction of the light transmittance. To further reduce the cost and enhance the light transmittance, it is desirable to reduce a number of the layers.

Therefore, if the dye is blended in the pressure sensitive adhesive used for adhering between the layers by the method of (d), the number of plastic film layers to be used is reduced, resulting in reduction of the cost and enhancement of the light transmittance. Thus, front filters for the plasma displays using a colored pressure sensitive adhesive to which a visible light-absorbable dye such as a methine dye and a tetraazaporphyrin-based dye has been blended are known (e.g., see Patent Documents 3 to 5).

It has been also proposed that the diimmonium-based dye which is the near infrared light absorbable dye preferably used for the front filter for the plasma display and a nickel dithiol-based dye known in Patent Document 4 are blended in the pressure sensitive adhesive (e.g., see Patent Documents 6 to 8).

Patent Document 1: JP 2003-262719-A Publication

Patent Document 2: JP Sho-64-069686-A Publication

Patent Document 3: JP 2004-107566-A Publication

Patent Document 4: JP2002-40233-A Publication

Patent Document 5: JP 2002-4372619-A Publication

Patent Document 6: JP Hei-9-230134-A Publication

Patent Document 7: JP Hei-10-156991-A Publication

Patent Document 8: JP 2001-207142-A Publication

### DISCLOSURE OF INVENTION

### Problem To Be Solved By the Invention

It is impossible to cover the aforementioned range of 800 to 1100 nm by only one type of the near infrared light absorbable dye. Thus, the multiple dyes, specifically the dye which absorbs the near infrared light at a relatively short wavelength and the dye which absorbs the near infrared light at a relatively long wavelength among the near infrared lights are combined and used. Considering the labor hour and the cost upon the production, it is preferable to mix them.

However, it has been found that when the dithiol metal complex described in Patent Document 1 is mixed with the other nickel metal complex-based near infrared dye to cut the absorption at 800 to 1100 nm, a ligand exchange occurs to produce another compound and an absorption maximum is shifted. That is, when the near infrared light absorbable filter is designed, if two or more near infrared light absorbable dyes having a predetermined absorption property are mixed, the absorption maximum is changed and no target near infrared light absorbable filter is obtained with difficulty. From the above, it is an object of the present invention to design and synthesize a compound group and compositions which have an absorbance throughout target 800 to 1100 nm, does not cause the above problems and does not shift the absorption maximum, and to provide a near infrared light absorbable dye composition which is excellent in light resistance and heat resistance and enhances a solubility in a solvent, and a near infrared light absorbable filter containing the same.

That is, it is the object of the present invention to provide a near infrared light absorbable dye composition which absorbs the near infrared light efficiently, has a high visible light transmittance, hardly becomes yellowish even in long term use, is excellent in light resistance, heat resistance and wet heat resistance, is not deteriorated in durability even when blended so as to have the absorbance in a wide range of 800 to 1100 nm, has no failure in shielding of the near infrared light due to color fading and requires a low cost for synthesis and isolation upon production, and a near infrared light absorbable filter containing the same. Furthermore, it is another object of the present invention to provide a near infrared light absorbable dye-containing pressure sensitive adhesive which hardly causes a deterioration of the dye due to mixing with a substance which imparts an adhesion.

### Means For Solving Problem

As a result of an extensive study for solving the above problems, the present inventor has found a near infrared light absorbable dye composition by which a near infrared light absorbable filter which efficiently absorbs near infrared lights in a wide range of 800 to 1100 nm, hardly becomes yellowish in long term use and has a high transmittance of visible lights at 400 to 700 nm is obtained, by combining multiple particular near infrared light absorbable dyes, and has found that the near infrared light absorbable dye composition has good heat resistance, wet heat resistance and light resistance even when mixed with an pressure sensitive adhesive, and has completed the present invention.

That is, the present invention consists in the near infrared light absorbable dye composition characterized by comprising a compound represented by the following general formula (1), a compound represented by the following general formula (2) and a compound represented by the following general formula (3):

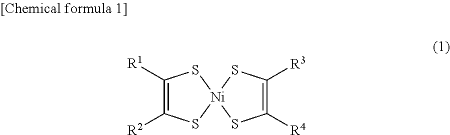

wherein, R¹, R², R³ and R⁴ each independently represent an organic group which has a carbon atom at a binding position in the general formula (1) and may have a substituent, or a hydrogen atom, and here, R¹ and R², R³ and R⁴ may together form a ring;

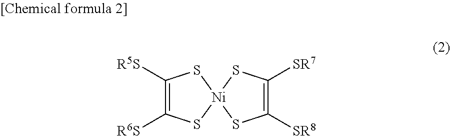

wherein R⁵, R⁵, R⁷ and R⁸ each independently represent an aliphatic hydrocarbon group which may have a substituent or an aryl group which may have a substituent, and here R⁵ and R⁶, R⁷ and R⁸ may together form a ring; and XR′R″R′″R″″ may be coordinated to the general formula (2) to take a salt type (here, X represents a group-15 atom and R′R″, R′″ and R″″ each independently represent an aliphatic hydrocarbon group which may have a substituent or an aryl group which may have a substituent).

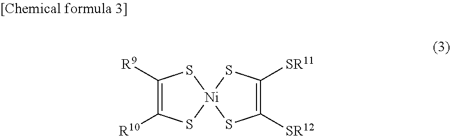

wherein R⁹ and R¹⁰ represent R¹ and R² or represent R³ and R⁴ in the general formula (1), and R¹¹ and R¹² represent R⁵ and R⁶ or represent R⁷ and R⁸ in the general formula (2).

The present invention also consists in a near infrared light absorbable dye composition solution in which the near infrared light absorbable dye composition containing the compounds represented by the general formulae (1), (2) and (3), which has been prepared by mixing a solution of the compound represented by the above general formula (1) and a solution of the compound represented by the above general formula (2) has been dissolved.

The present invention also consists in a near infrared light absorbable dye-containing pressure sensitive adhesive characterized by containing the near infrared light absorbable dye composition, and consists in a near infrared light absorbable dye-containing pressure sensitive adhesive characterized by being obtained from the near infrared light absorbable dye composition solution.

The present invention also consists in a near infrared light absorbable filter characterized by containing the near infrared light absorbable dye composition, and consists in a near infrared light absorbable filter characterized by being produced using the near infrared light absorbable dye-containing pressure sensitive adhesive.

### EFFECT OF THE INVENTION

According to the present invention, it is possible to provide the near infrared light absorbable dye composition which is excellent in light resistance, heat resistance and wet heat resistance, cuts the light in the wide range in the near infrared light region of 800 to 1100 nm, has the high visible light transmittance, hardly becomes yellowish even in long term use, is not deteriorated in durability even when the multiple near infrared light absorbable dyes are blended and has no failure in shielding of the near infrared light due to the color fading, and the solution containing the same. Furthermore it is possible to provide the near infrared light absorbable dye-containing pressure sensitive adhesive which hardly causes the deterioration of the dye even when mixed with the pressure sensitive adhesive. Thereby, it is possible to provide the near infrared light absorbable filter which has an excellent shielding function for the near infrared light generated from electronic display screens such as PDP and is excellent in durability.

### BRIEF DESCRIPTION OF DRAWINGS

FIG. 1 is a graph showing an absorbance spectrum of a solution of a compound (1-a);

FIG. 2 is a graph showing a transmittance spectrum of a near infrared light absorbable filter containing the compound (1-a);

FIG. 3 is a graph showing an absorbance spectrum of a solution of a compound (2-a);

FIG. 4 is a graph showing a transmittance spectrum of a near infrared light absorbable filter containing the compound (2-a);

FIG. 5 is a graph showing an absorbance spectrum of a solution of a compound (3-a); and

FIG. 6 is a graph showing an absorbance spectrum of a solution of a near infrared light absorbable composition containing the compounds (1-a), (2-a) and (3-a) in Example 10.

### BEST MODES FOR CARRYING OUT THE INVENTION

The present invention will be described in detail below. It is essential that the near infrared light absorbable dye composition of the present invention comprises the compound represented by the following general formula (1):

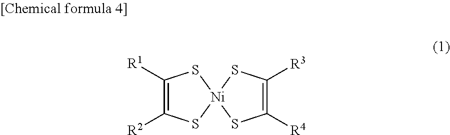

wherein R¹, R², R³ and R⁴ each independently represent an organic group which has a carbon atom at a binding position in the general formula (1) and may have a substituent, or a hydrogen atom, and here, R¹ and R², R³ and R⁴ may together form a ring.

The organic group in the “organic group which may have the substituent” and has the carbon atom at the binding position in the above general formula (1) is not particularly limited, and any organic groups may be used. Examples of this organic group include hydrocarbon groups, heterocyclic groups, carbonyl groups and cyano groups.

In addition, “Having the carbon atom at the binding position in the general formula (1)” means that a chemical bond of —R¹, —R², —R³ and —R⁴ in the general formula (1) is connected to the carbon atom in the organic group.

The above hydrocarbon group is not particularly limited and any hydrocarbon groups may be used. Examples thereof include aliphatic hydrocarbon groups such as alkyl, alkenyl and alkynyl groups, and aryl groups. R¹, R², R³ and R⁴ are the organic groups which may be substituted, and the substituents when the organic group is substituted will be described later.

As the above alkyl group, any of straight, branched and cyclic alkyl groups can be used. The number of carbon atoms in the above alkyl group is not limited and is optional as long as the alkyl group does not depart from the spirit of the present invention, but is typically 20 or less and preferably 15 or less. The alkyl group includes, for example, methyl, ethyl, n-propyl, n-butyl, 2-methylpropyl, 2-methylbutyl, 3-methylbutyl, cyclohexylmethyl, neopentyl, 2-ethylbutyl, isopropyl, 2-butyl, cyclohexyl, 3-pentyl, tert-butyl and 1,1-dimethylpropyl groups.

As the alkenyl group, any of straight, branched and cyclic alkenyl groups can be used. The number of carbon atoms in the above alkenyl group is not limited and is optional as long as the alkenyl group does not depart from the spirit of the present invention, but is typically 20 or less and preferably 15 or less. The alkenyl group includes, for example, vinyl, allyl, propenyl, stylyl and isopropenyl groups.

As the alkynyl group, any of straight, branched and cyclic alkynyl groups can be used. The number of carbon atoms in the above alkynyl group is not limited and is optional as long as the alkynyl group does not depart from the spirit of the present invention, but is typically 20 or less and preferably 15 or less. The alkynyl group includes, for example, ethynyl, diethynyl, phenylethynyl and trimethylsilylethynyl groups.

The aryl group is not particularly limited, and the number of carbon atoms is not limited and is optional as long as the aryl group does not depart from the spirit of the present invention, but is typically 25 or less and preferably 15 or less. The aryl group includes, for example, phenyl, naphthyl, anthranil, biphenyl, fluorenyl, phenanthrenyl, azulenyl and metallocene ring groups.

The heterocyclic group is not particularly limited, and any of the heterocyclic groups can be used. The number of carbon atoms in the heterocyclic group is not limited and is optional as long as the heterocyclic group does not depart from the spirit of the present invention, but is typically 25 or less and preferably 15 or less. Examples of the heterocyclic group include thienyl, furyl, pyrrolyl, pyrrolidyl, pyridyl, imidazolyl and indolyl groups.

The carbonyl group is not particularly limited, and examples thereof include alkylaminocarbonyl (carbamoyl [—CONRR′]), arylaminocarbonyl, alkoxycarbonyl (—C(O)OR), aryloxycarbonyl (—C(O)OR), acyl (—COR) and heterocyclic oxycarbonyl (—C(O)OR) groups.

R in the acyl group (—COR) and R and R′ in the carbamoyl group (—CONRR′) include those which are the same as the specific examples in the aliphatic hydrocarbon, aryl and heterocyclic groups mentioned above. R in the alkoxycarbonyl group (—C(O)OR) includes those which are the same as the specific examples in the aliphatic hydrocarbon groups mentioned above. R in the aryloxycarbonyl (—C(O)OR) includes those which are the same as the specific examples in the aryl groups mentioned above. R in the heterocyclic oxycarbonyl (—C(O)OR) group includes those which are the same as the specific examples in the heterocyclic groups mentioned above. Aldehyde group where R is hydrogen is also included.

The alkylaminocarbonyl group (carbamoyl [—CONRR′]) is not limited, and any of the alkylaminocarbonyl groups can be used. Any of straight, branched and cyclic alkylaminocarbonyl groups can be used. The number of carbon atoms in the alkylaminocarbonyl group is not limited and is optional as long as the alkylaminocarbonyl group does not depart from the spirit of the present invention, but is typically 20 or less and preferably 15 or less. Examples of the alkylaminocarbonyl group include methylaminocarbonyl, n-butylaminocarbonyl, diethylaminocarbonyl, 2-ethylhexylaminocarbonyl and di-n-octylaminocarbony groups.

The arylaminocarbonyl group is not limited, and any of the arylaminocarbonyl groups can be used. The number of carbon atoms in the arylaminocarbonyl group is not limited and is optional as long as the arylaminocarbonyl group does not depart from the spirit of the present invention, but is typically 25 or less and preferably 15 or less. Examples of the arylaminocarbonyl group include phenylaminocarbonyl, ditolylaminocarbonyl and naphthylaminocarbonyl groups.

The alkoxycarbonyl group is not limited, and any of the alkoxycarbonyl groups can be used. Any of straight, branched and cyclic alkoxycarbonyl groups can also be used. The number of carbon atoms in the alkoxycarbonyl group is not limited and is optional as long as the alkoxycarbonyl group does not depart from the spirit of the present invention, but is typically 20 or less and preferably 15 or less. Examples of the alkoxycarbonyl group include methoxycarbonyl, ethoxycarbonyl, t-butoxycarbonyl, n-hexyloxycarbonyl, isobutoxycarbonyl, benzyloxycarbonyl and phenethyloxycarbonyl groups.

The aryloxycarbonyl group is not limited, and any of the aryloxycarbonyl groups can be used. The number of carbon atoms in the aryloxycarbonyl group is not limited and is optional as long as the aryloxycarbonyl group does not depart from the spirit of the present invention, but is typically 25 or less and preferably 15 or less. Examples of the aryloxycarbonyl group include phenyloxycarbonyl, tolyloxycarbonyl, p-fluorophenyloxycarbonyl, naphthyloxycarbonyl and xylyloxycarbonyl groups.

The acyl group is not limited, and any of the acyl groups can be used. Any of straight, branched and cyclic acyl groups can also be used. The number of carbon atoms in the acyl group is not limited and is optional as long as the acyl group does not depart from the spirit of the present invention, but is typically 20 or less and preferably 15 or less. Examples of the acyl group include acetyl, ethylcarbonyl, benzoyl, formyl and pivaloyl groups.

R¹, R², R³ and R⁴ are particularly preferably the hydrocarbon groups, the heterocyclic groups or the hydrogen atoms. Among them, as the hydrocarbon group, alkyl, alkenyl or aryl groups are particularly preferable, and as the heterocyclic group, heteroaryl is preferable. Furthermore, among them, aryl groups such as phenyl and naphthyl are more preferable.

The above R¹, R², R³ and R⁴ each independently may have the substituent. When R¹, R², R³ and R⁴ are substituted, the substituents are not particularly limited as long as the substituents do not adversely affect the stability of the dithiolate-based metal complex, and they may be substituted with the optional substituents. Specific examples of these substituents include halogen atoms, nitro, cyano, hydroxyl, alkyl, alkenyl, alkynyl, aryl, heteroaryl, alkoxy, aryloxy, heteroaryloxy, alkylthio, arylthio, heteroarylthio, amino, acyl, aminoacyl, ureide, sulfonamide, carbamoyl, sulfamoyl, sulfamoylamino, alkoxycarbonyl, aryloxycarbonyl, heteroaryloxycarbonyl, alkylsulfonyl, arylsulfonyl, heteroarylsulfonyl, imide groups, and substituted or unsubstituted silyl group.

Concerning these substituents, specific examples are further exemplified. Alkyl groups such as methyl and ethyl having about 1 to 6 carbon atoms; alkenyl groups such as vinyl and propylenyl having about 2 to 6 carbon atoms; alkynyl groups such as ethynyl having about 2 to 6 carbon atoms; aryl groups such as phenyl and naphthyl having about 6 to 20 carbon atoms; heteroaryl groups such as thienyl, furyl and pyridyl having about 3 to 20 carbon atoms; alkoxy groups such as methoxy, ethoxy, propoxy and butoxy having about 1 to 6 carbon atoms; aryloxy groups such as phenoxy and naphthoxy having about 6 to 20 carbon atoms; heteroaryloxy groups such as pyridyloxy and thienyloxy having about 3 to 20 carbon atoms; alkylthio groups such as methylthio and ethylthio having about 1 to 6 carbon atoms; arylthio groups such as phenylthio and naphthylthio having about 6 to 20 carbon atoms; heteroarylthio groups such as pyridylthio and thienylthio having about 3 to 20 carbon atoms; amino groups which may have the substituent such as alkyl having about 1 to 20 carbon atoms and aryl, e.g., dimethylamino and diphenylamino; acyl groups such as acetyl and pivaloyl having about 2 to 20 carbon atoms; acylamino groups such as acetylamino and propionylamino having about 2 to 20 carbon atoms; ureide groups such as 3-methylureide having about 2 to 20 carbon atoms; sulfonamide groups such as methanesulfonamide and benzenesulfonamide having about 1 to 20 carbon atoms; carbamoyl groups such as dimethylcarbamoyl and ethylcarbamoyl having about 1 to 20 carbon atoms; sulfamoyl groups such as ethylsulfamoyl having about 1 to 20 carbon atoms; sulfamoylamino groups such as dimethylsulfamoylamino having about 1 to 20 carbon atoms; alkoxycarbonyl groups such as methoxycarbonyl and ethoxycarbonyl having about 2 to 6 carbon atoms; aryloxycarbonyl groups such as phenoxycarbonyl and naphthoxycarbonyl having about 7 to 20 carbon atoms; heteroaryloxycarbonyl groups such as pyridyloxycarbonyl having about 6 to 20 carbon atoms; alkylsulfonyl groups such as methanesulfonyl, ethanesulfonyl and trifluoromethanesulfonyl having about 1 to 6 carbon atoms; arylsulfonyl groups such as benzenesulfonyl and monofluorobenzenesulfonyl having about 6 to 20 carbon atoms; heteroaryloxysulfonyl groups such as thienylsulfonyl having about 3 to 20 carbon atoms; imide groups such as phthalimide having about 4 to 20 carbon atoms; and silyl groups substituted with the substituent selected from the group consisting of alkyl and aryl groups are included.

Among the above substituents which substitute the above R¹, R², R³ and R⁴, one or more substituents selected from the group consisting of amino, hydroxyl, nitro, cyano groups and halogen atoms which may be substituted with alkyl, alkenyl, alkynyl, alkoxy, aryl, aryloxy, acyl, alkoxycarbonyl, aryloxycarbonyl, alkyl and/or aryl groups are preferable in terms of good heat resistance, wet heat resistance and light resistance.

Furthermore, among the above substituents, the alkoxy groups are particularly preferable because they particularly contribute to the good heat resistance, wet heat resistance and light resistance. Among them, the alkoxy groups such as methoxy, ethoxy, propoxy, butoxy, pentoxy, hexoxy and heptoxy having 1 to 7 carbon atoms are more preferable.

It is particularly preferable in terms of good heat resistance, wet heat resistance and light resistance that the alkoxy group as the “substituent” substitutes the aryl group such as phenyl or naphthyl which is the “organic group”.

When the “organic group” is the aryl group, in order to enhance the stability of the compound itself of the general formula (1), it is preferable to have the substituent having total 4 or more carbon atoms on the carbon atom (on an ortho position when the aryl group is phenyl) adjacent to the carbon atom present at the binding position in the general formula (1). Such a substituent may contain oxygen, sulfur and nitrogen atoms in addition to the carbon atoms.

Particularly preferable R¹, R², R³ and R⁴ are the phenyl groups or the naphthyl groups having the alkoxy group such as methoxy, ethoxy, propoxy, butoxy, pentoxy, hexoxy or heptoxy having 1 to 7 carbon atoms at least at the ortho position.

It is also preferable that some of organic groups in R¹, R², R³ and R⁴ have no substituent. R¹ and R² may be the same or different, but are preferably different. R³ and R⁴ may also be the same or different, but are preferably different.

The above R¹ and R², R³ and R⁴ may be bound mutually and together form the ring. Specifically, it is preferable to form the ring by alkylene groups such as —CH₂—CH₂—, —CH₂—CH₂—CH₂—, —CH₂—CF₂—CH₂—, —CH₂—CH₂—CH₂—CH₂—, —CH(Ph)—CH₂— and —CH(Me)-CH₂— which may be substituted, alkenylene groups such as —CH═CH—, C(Me)=CH—, —CH═CH—CH₂—, —CH═CH—CH₂—CH₂— and —CH═CH—CH₂—CH₂—CH═CH— which may be substituted, and alkylene groups and the like containing a linking group such as —CH₂—S—CH₂—, —CH₂—S—CH═CH₂—, —CH₂—CH₂—S—CH₂—CH₂—, —CH₂—O—CH₂—, —CH₂—O—CH═CH₂—, —CH₂—C(═O)—CH₂— or —CH₂—CH₂—O—CH₂—CH₂—.

Furthermore, the compound represented by the general formula (1) may be a salt type compound as described later in a section for the compound represented by the general formula (2). In the case of the salt type compound, preferable XR′R″R′″R″″ is the same as in the case of the compound represented by the general formula (2). Here X represents the group-15 atom, and R′R″, R′″ and R″″ each independently represent aliphatic hydrocarbon groups which may have the substituent or aryl groups which may have the substituent.

Preferable specific examples of the compound represented by the general formula (1) include but are not limited to, for example, those exemplified below.

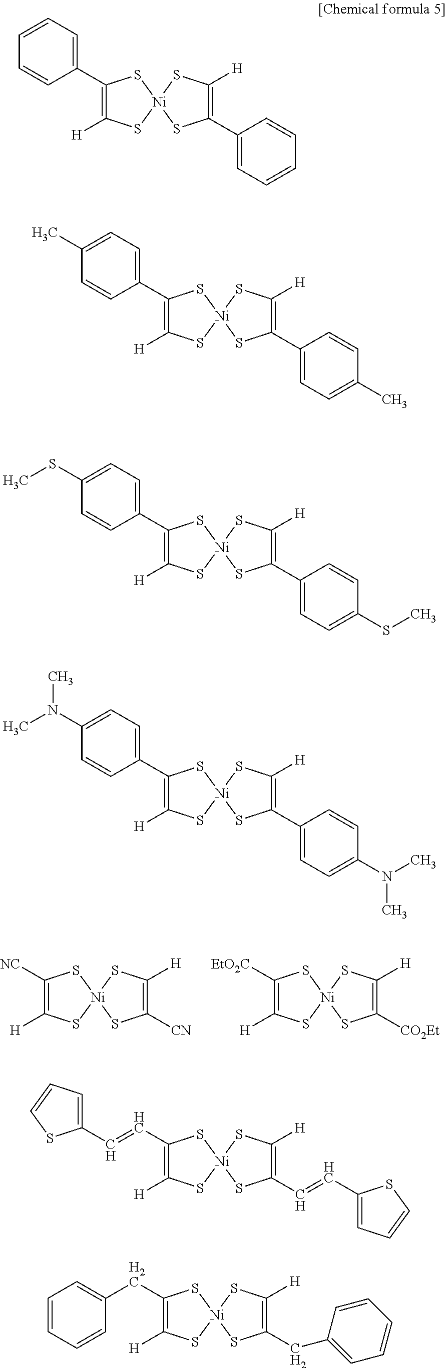

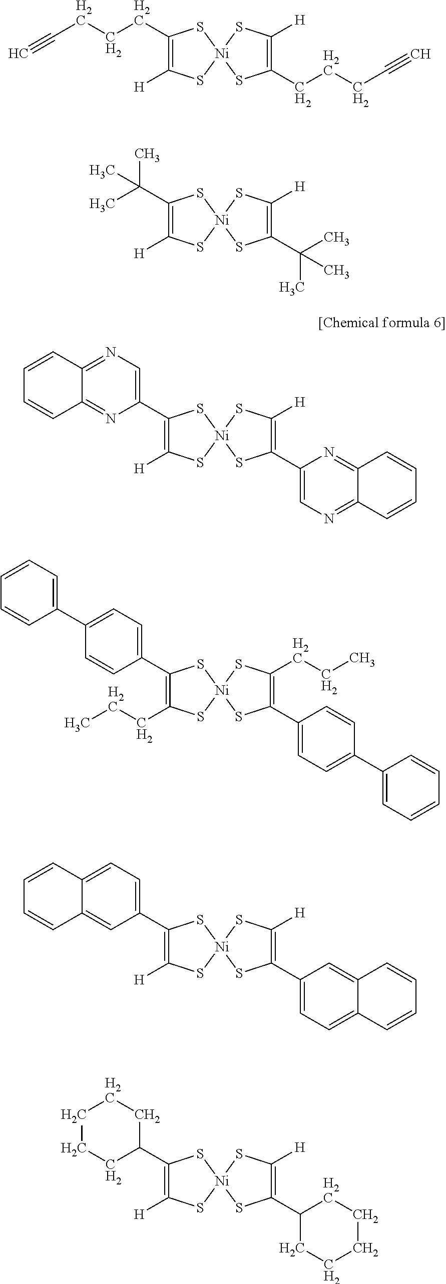

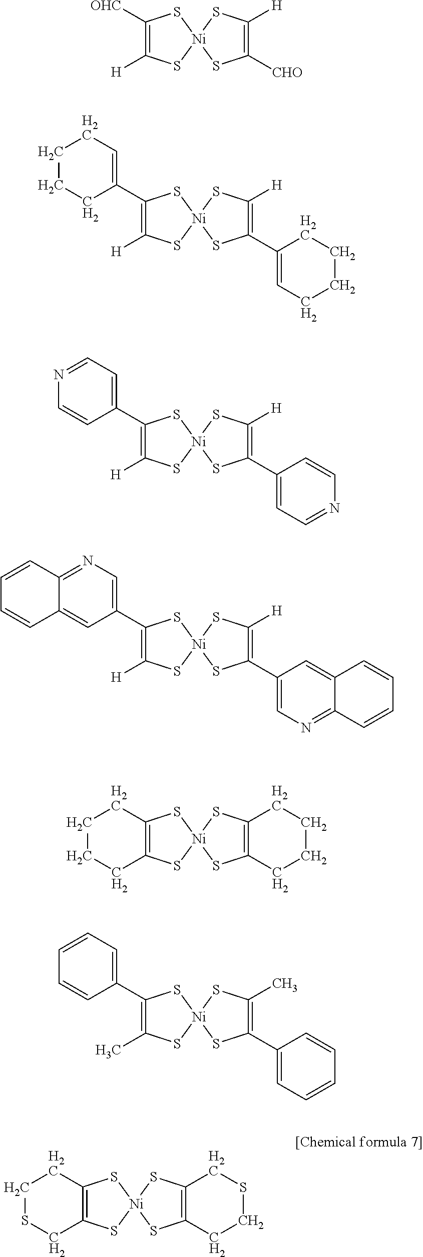

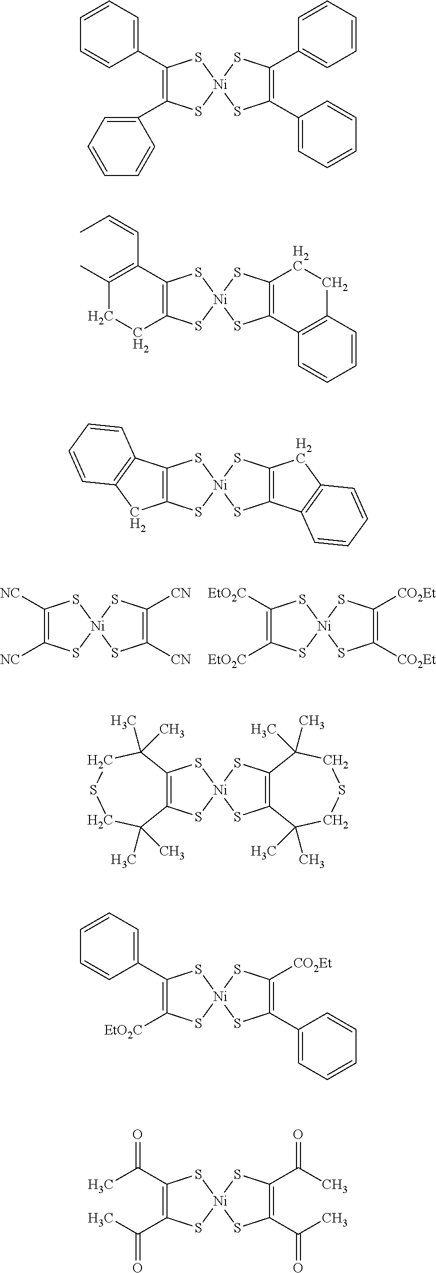

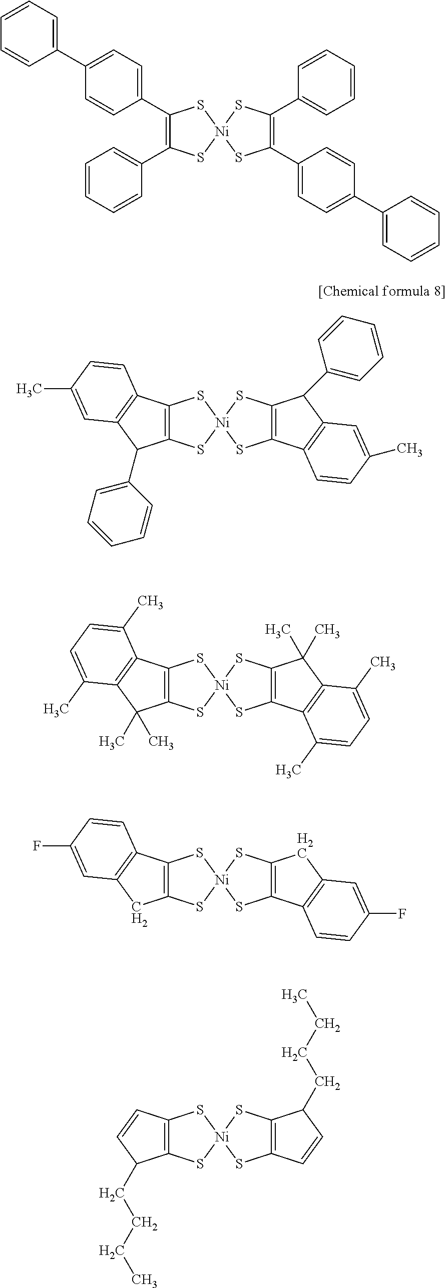

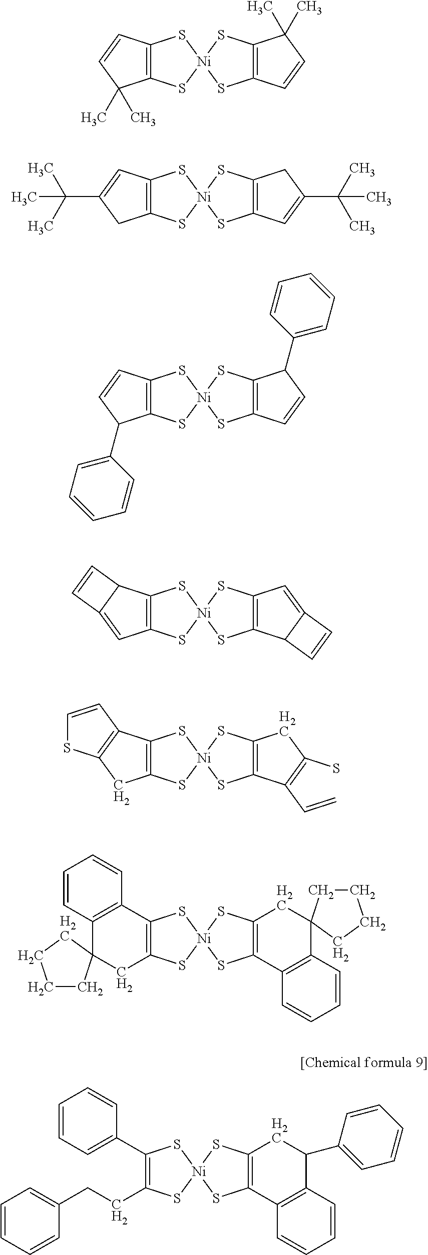

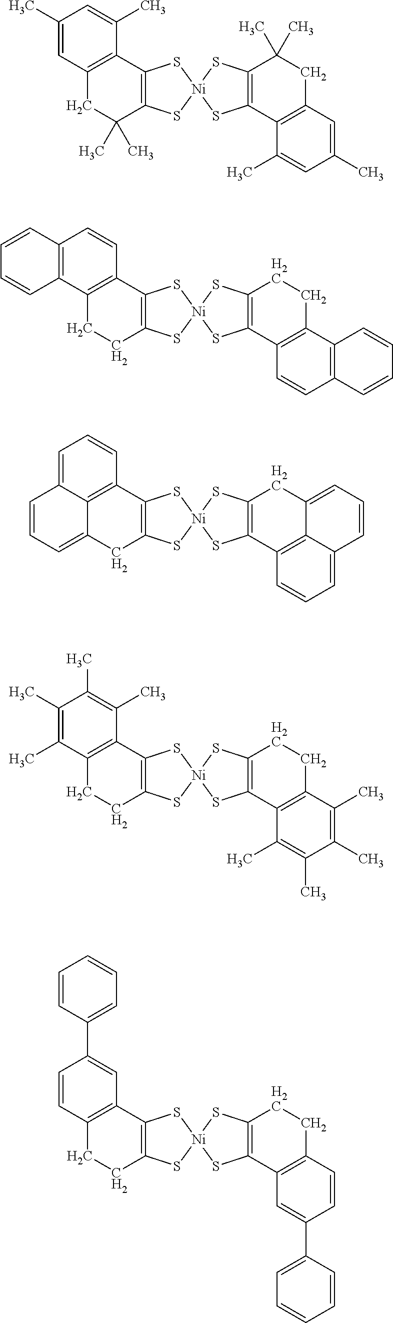

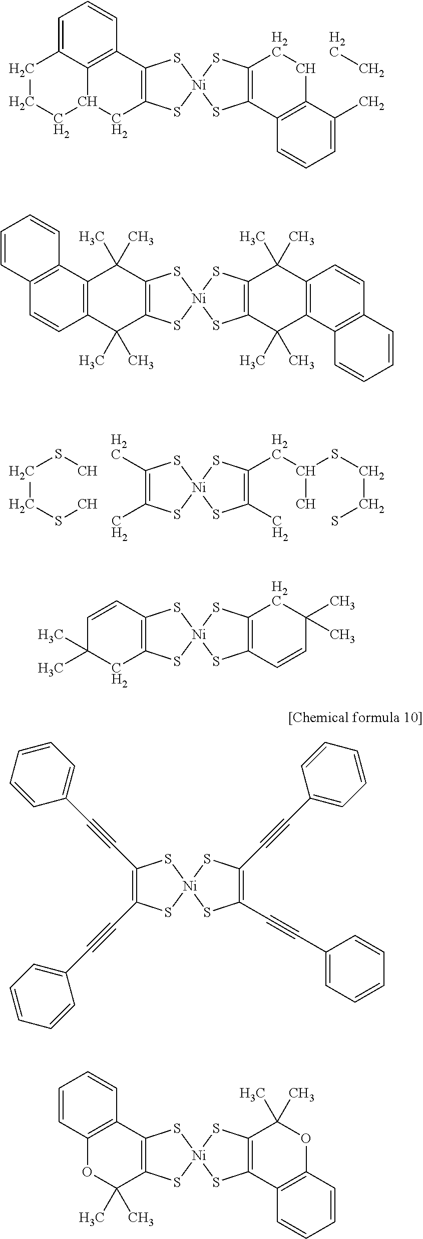

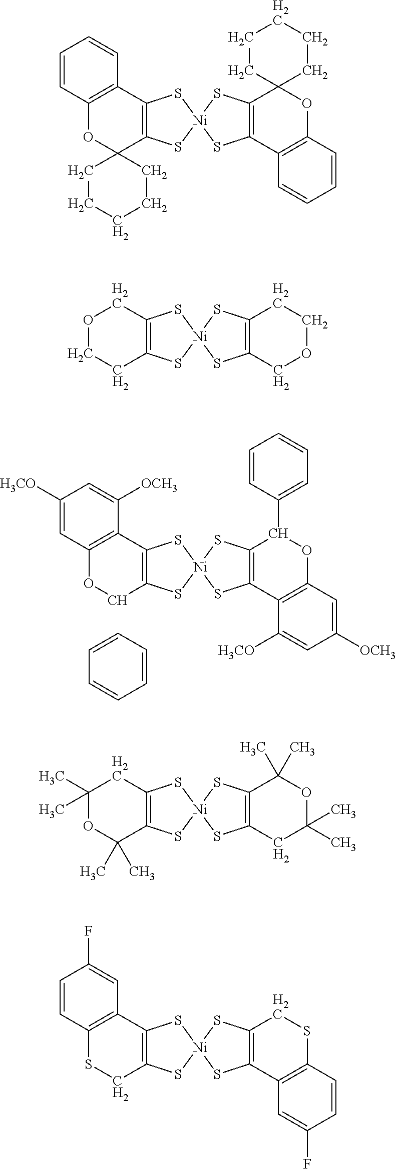

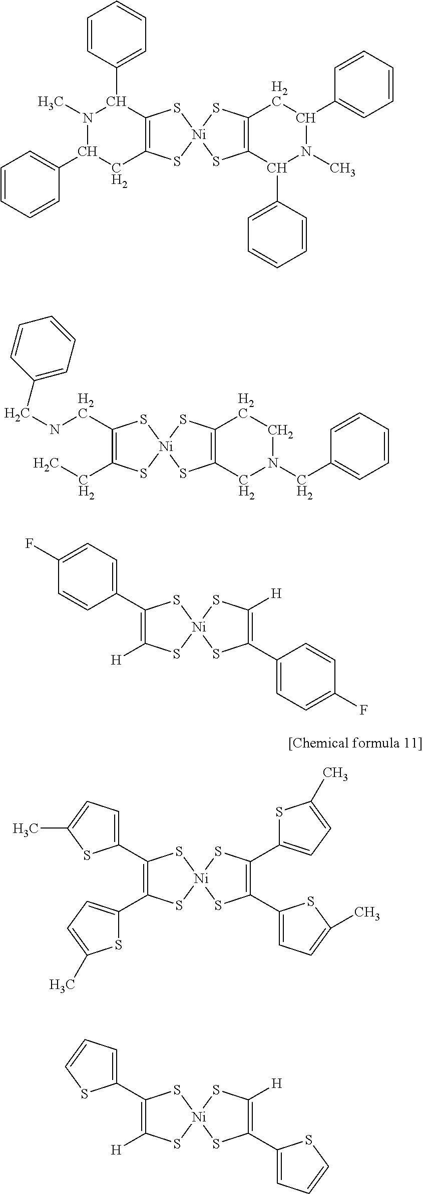

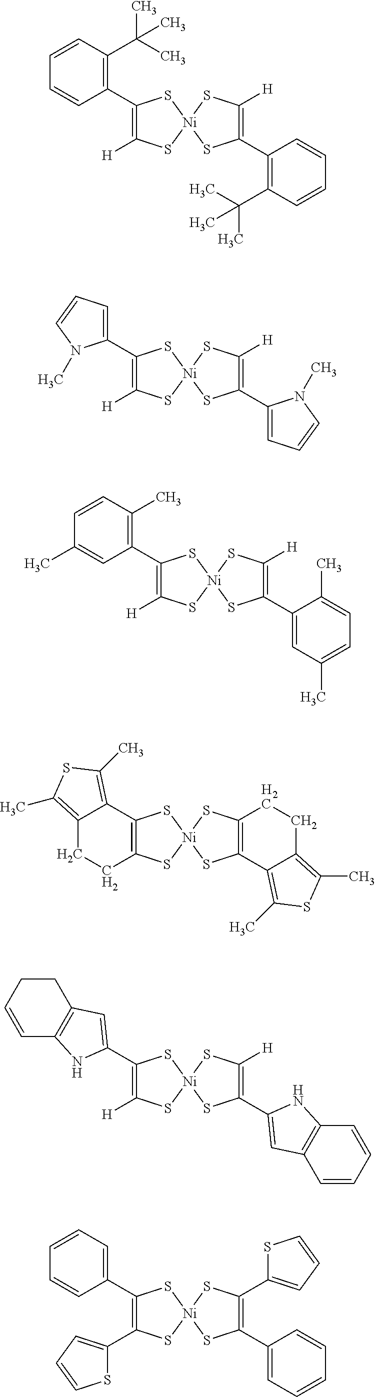

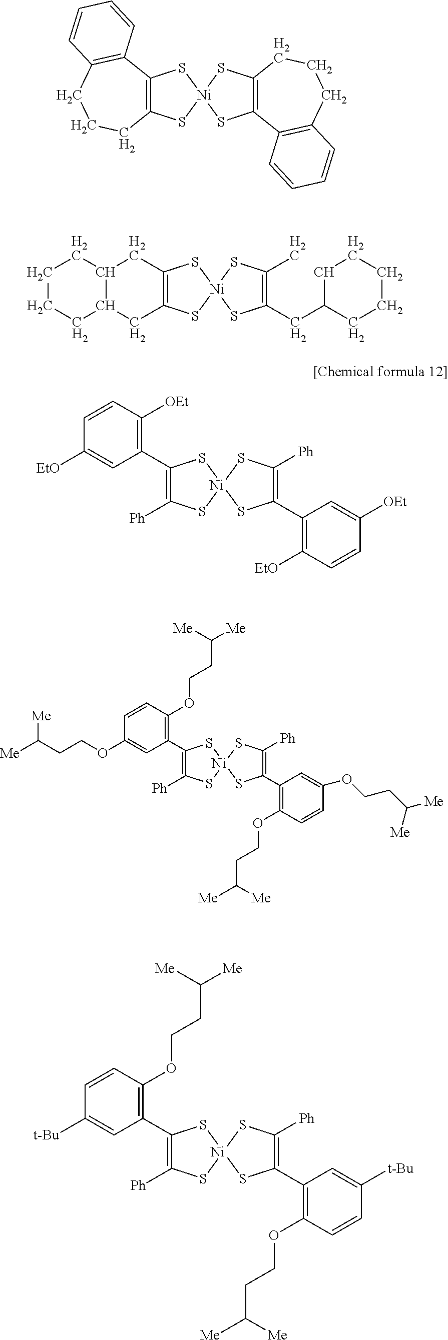

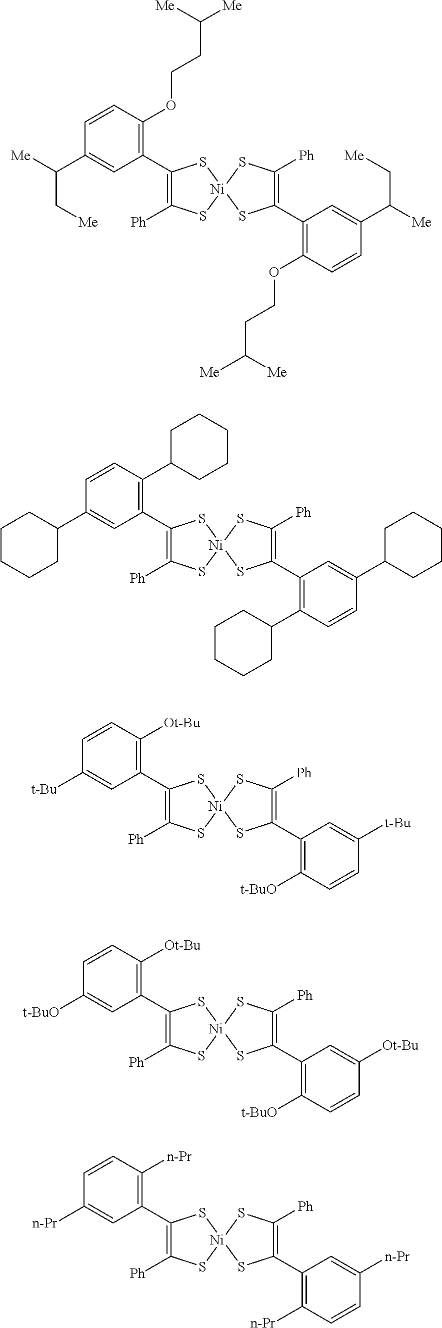

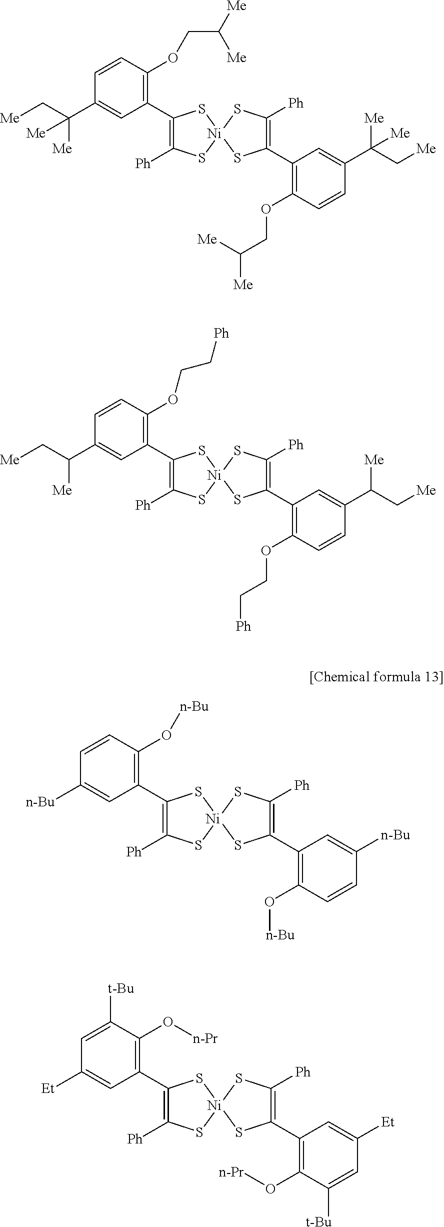

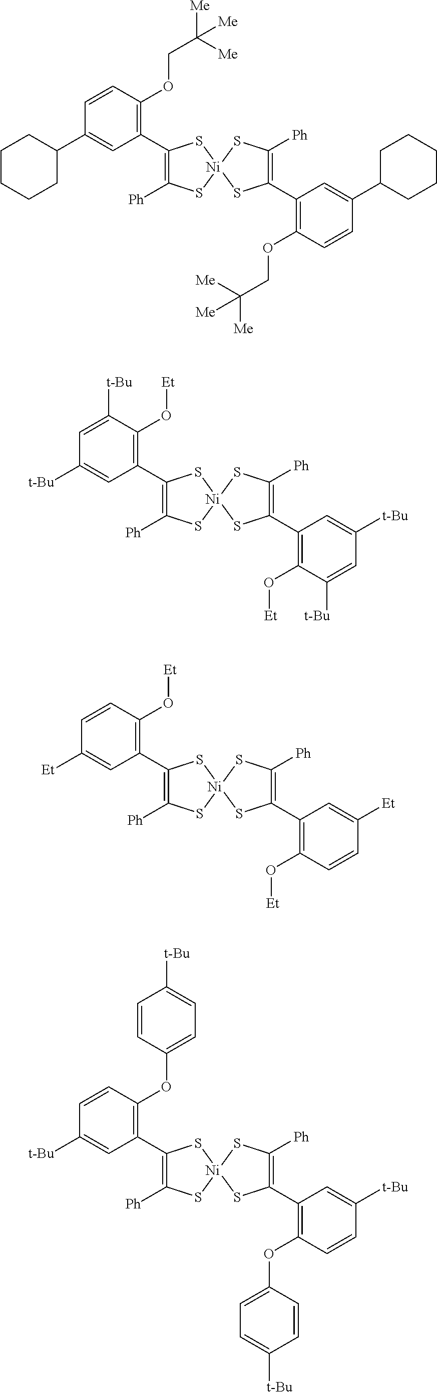

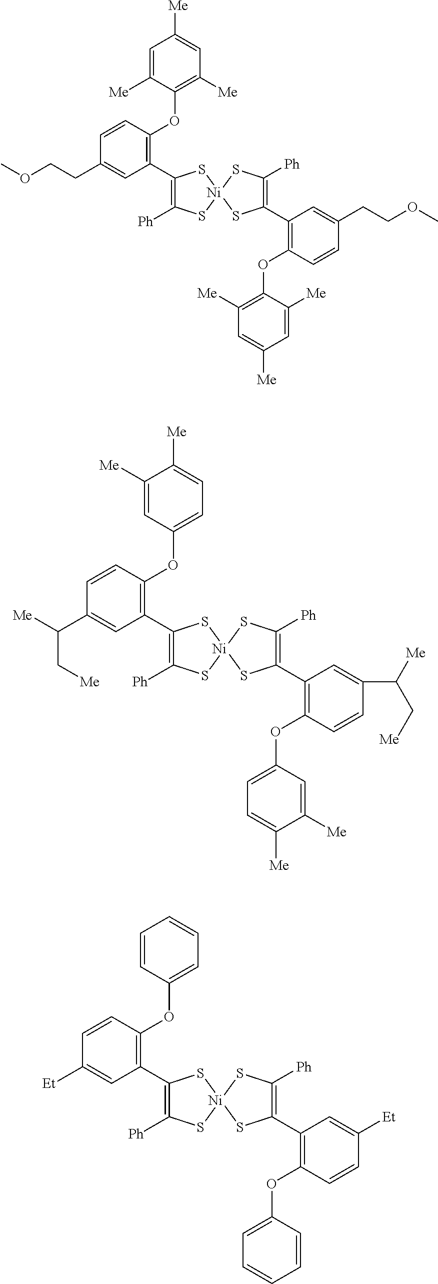

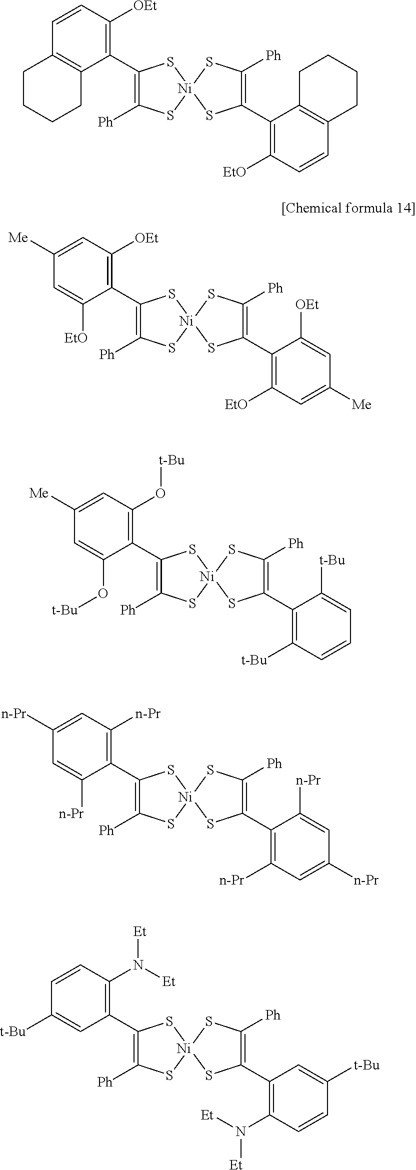

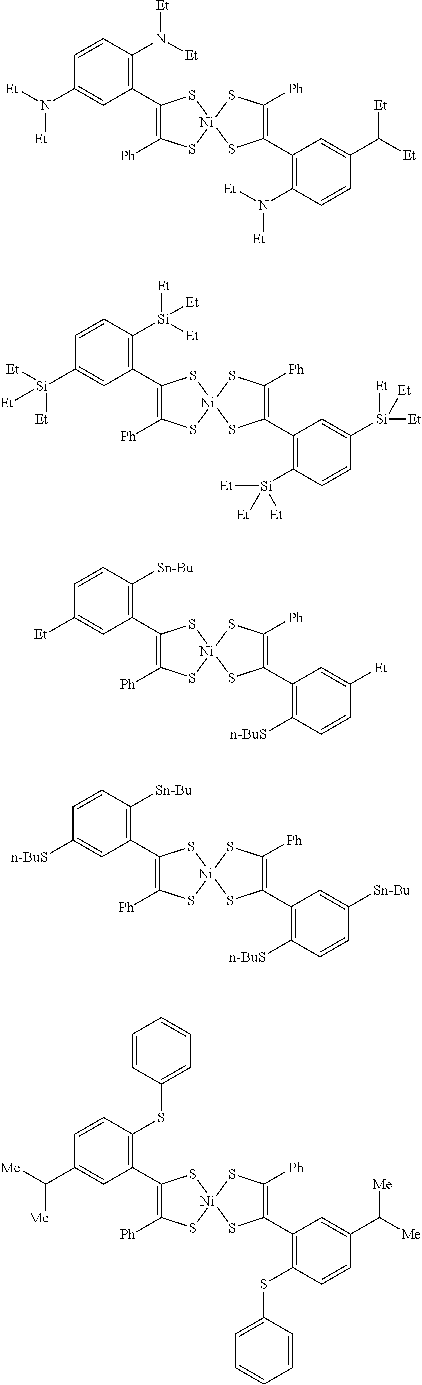

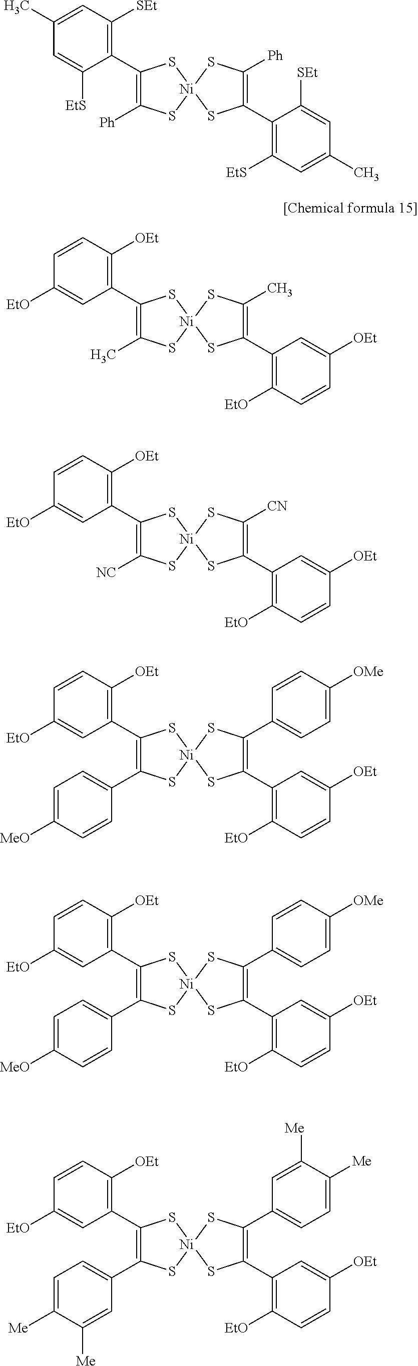

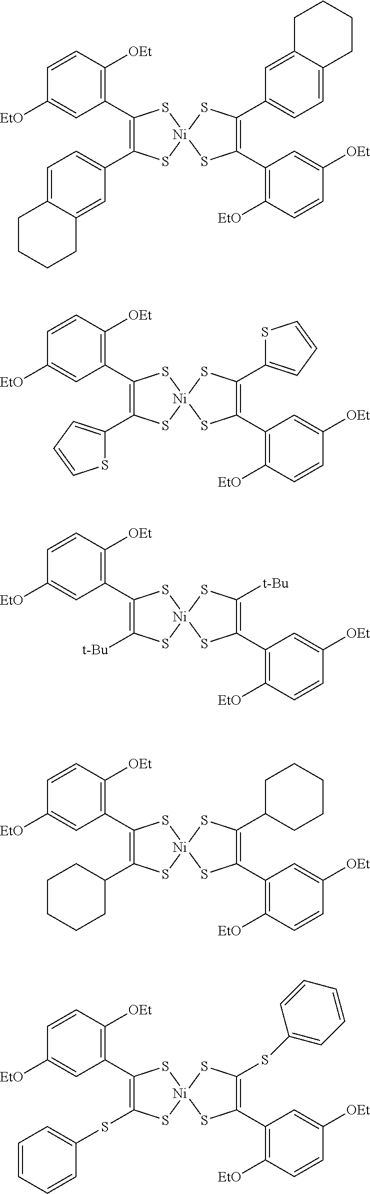

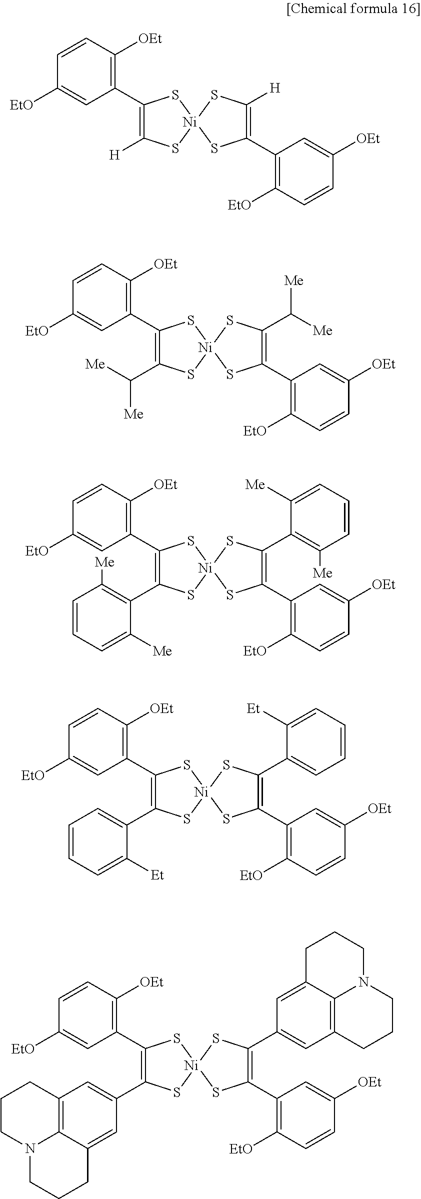

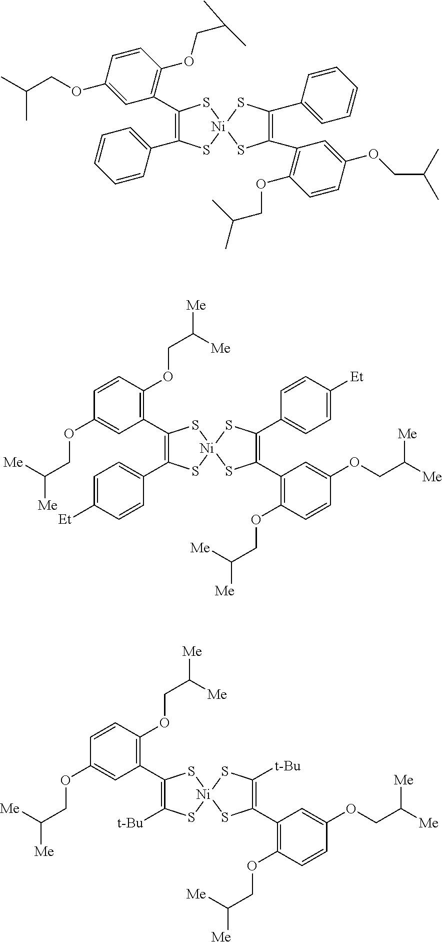

It is essential that the near infrared light absorbable dye composition of the present invention further comprises a compound represented by the following general formula (2):

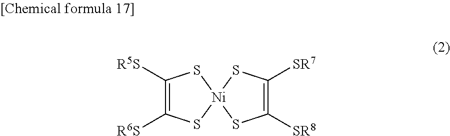

wherein R⁵, R⁶, R⁷ and R⁸ each independently represent aliphatic hydrocarbon groups which may have the substituent or aryl groups which may have the substituent, and here R⁵ and R⁶, R⁷ and R⁸ may together form a ring; and XR′R″R′″R″″ may be coordinated to the general formula (2) to take the salt type (here, X represents the group-15 atom and R′R″, R′″ and R″″ each independently represent aliphatic hydrocarbon groups which may have the substituent or aryl groups which may have the substituent).

The “aliphatic hydrocarbon group” in the above general formula (2) includes straight, branched or cyclic alkyl groups such as methyl, ethyl, n-propyl, n-butyl, 2-methylpropyl, 2-methylbutyl, 3-methylbutyl, cyclohexylmethyl, neopentyl, 2-ethylbutyl, isopropyl, 2-butyl, cyclohexyl, 3-pentyl, tert-butyl and 1,1-dimethylpropyl groups, alkenyl groups such as 2-propenyl, 2-butenyl, 3-butenyl and 2,4-pentadienyl, and alkynyl groups such as ethynyl.

The aryl group includes phenyl and naphthyl.

The substituents for the aliphatic hydrocarbon groups and the aryl groups in R⁵ to R⁸ are not particularly limited as long as they do not adversely affect the stability of the dithiolate-based complex, and include, for example, halogen atoms, hydroxyl, nitro, cyano, alkyl, alkenyl, alkynyl, aryl, heteroaryl, alkoxy, aryloxy, heteroaryloxy, alkylthio, arylthio, heteroarylthio, amino, acyl, aminoacyl, ureide, sulfonamide, carbamoyl, sulfamoyl, sulfamoylamino, alkoxycarbonyl, aryloxycarbonyl, heteroaryloxycarbonyl, alkylsulfonyl, arylsulfonyl, heteroarylsulfonyl, imide and silyl groups.

These substituents specifically include alkyl groups such as methyl and ethyl having about 1 to 6 carbon atoms; alkenyl groups such as ethynyl and propylenyl having about 2 to 6 carbon atoms; alkynyl groups such as acetylenyl having about 2 to 6 carbon atoms; aryl groups such as phenyl and naphthyl having about 6 to 20 carbon atoms; heteroaryl groups such as thienyl, furyl and pyridyl having about 3 to 20 carbon atoms; alkoxy groups such as ethoxy and propoxy having about 1 to 6 carbon atoms; aryloxy groups such as phenoxy and naphthoxy having about 6 to 20 carbon atoms; heteroaryloxy groups such as pyridyloxy and thienyloxy having about 3 to 20 carbon atoms; alkylthio groups such as methylthio and ethylthio having about 1 to 6 carbon atoms; arylthio groups such as phenylthio and naphthylthio having about 6 to 20 carbon atoms; heteroarylthio groups such as pyridylthio and thienylthio having about 3 to 20 carbon atoms; amino groups which may have the substituent having about 1 to 20 carbon atoms such as dimethylamino and diphenylamino; acyl groups such as acetyl and pivaloyl having about 2 to 20 carbon atoms; acylamino groups such as acetylamino and propionylamino having about 2 to 20 carbon atoms; ureide groups such as 3-methylureide having about 2 to 20 carbon atoms; sulfonamide groups such as methanesulfonamide and benzenesulfonamide having about 1 to 20 carbon atoms; carbamoyl groups such as dimethylcarbamoyl and ethylcarbamoyl having about 1 to 20 carbon atoms; sulfamoyl groups such as ethylsulfamoyl having about 1 to 20 carbon atoms; sulfamoylamino groups such as dimethylsulfamoylamino having about 1 to 20 carbon atoms; alkoxycarbonyl groups such as methoxycarbonyl and ethoxycarbonyl having about 2 to 6 carbon atoms; aryloxycarbonyl groups such as phenoxycarbonyl and naphthoxycarbonyl having about 7 to 20 carbon atoms; heteroaryloxycarbonyl groups such as pyridyloxycarbonyl having about 6 to 20 carbon atoms; alkylsulfonyl groups such as methanesulfonyl, ethanesulfonyl and trifluoromethanesulfonyl having about 1 to 6 carbon atoms; arylsulfonyl groups such as benzenesulfonyl and monofluorobenzenesulfonyl having about 6 to 20 carbon atoms; heteroaryloxysulfonyl groups such as thienylsulfonyl having about 3 to 20 carbon atoms; imide groups such as phthalimide having about 4 to 20 carbon atoms; and silyl groups tri-substituted with the substituents selected from the group consisting of alkyl and aryl groups.

The above R⁵ and R⁶, or R⁷ and R⁸ may together form the ring. Specifically, it is preferable to form the ring by alkylene groups such as —CH₂—CH₂—, —CH₂—CH₂—CH₂—, —CH₂—CF₂—CH₂—, —CH₂—CH₂—CH₂—CH₂—, —CH(Ph)-CH₂— and —CH(Me)-CH₂— which may be substituted, alkenylene groups such as —CH═CH—, C(Me)=CH—, —CH═CH—CH₂—, —CH═CH—CH₂—CH₂— and —CH═CH—CH₂—CH₂—CH═CH— which may be substituted, and alkylene groups and the like containing the linking group such as —CH₂—S—CH₂—, —CH₂—S—CH═CH₂—, —CH₂—CH₂—S—CH₂—CH₂—, —CH₂—O—CH₂—, —CH₂—O—CH═CH₂—, —CH₂—C(═O)—CH₂— or —CH₂—CH₂—O—CH₂—CH₂—.

The above R⁵, R⁶, R⁷ and R⁸ are preferably unsubstituted alkyl groups or alkyl groups having the substituent. Particularly preferable are unsubstituted alkyl groups, and alkyl groups having the halogen atom (particularly preferably the fluorine atom), cyano, alkyl or aryl as the substituent. The unsubstituted alkyl groups are more preferable in terms of good heat resistance, wet heat resistance and light resistance.

R⁵ and R⁶ may be the same or different but is preferable the same, and R⁷ and R⁸ may be the same or different but is preferable the same. R⁵, R⁶, R⁷ and R⁸ may be the same or different but all are more preferably the same.

The compound represented by XR′R″R′″R″″ may be coordinated to the compound represented by the above general formula (2) to take the salt type. When the salt is formed, the salt is the salt represented by the following general formula (A) where X is cation or the salt represented by the following general formula (B) where the entire XR′R″R′″R″″ is cation, and among them, the salt represented by the general formula (B) is preferable.

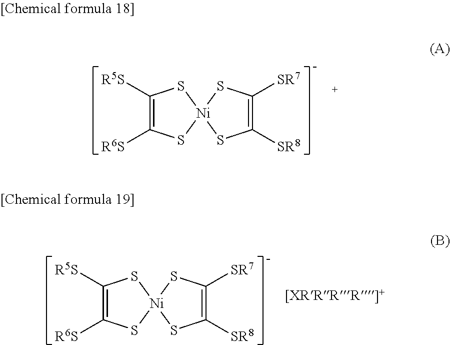

In the general formula (A) and the general formula (B), R⁵, R⁶, R⁷ and R⁸ each independently represent aliphatic hydrocarbon groups which may have the substituent or aryl groups which may have the substituent, and here R⁵ and R⁶, R⁷ and R⁸ may together form a ring. X represents the group-15 atom and R′, R″, R′″ and R″″ each independently represent aliphatic hydrocarbon groups which may have the substituent or aryl groups which may have the substituent.

R⁵, R⁶, R⁷ and R⁸ in the general formula (A) and the general formula (B) include those which are the same as those described in the above general formula (2), and preferable ones are also the same. In the general formula (A) and the general formula (B), X represents the group-15 atom, and is preferably a nitrogen or phosphorous atom.

R′, R″, R′″ and R″″ each independently represent aliphatic hydrocarbon groups which may have the substituent or aryl groups which may have the substituent. The aliphatic hydrocarbon groups and the aryl groups include the same groups as aliphatic hydrocarbon groups and aryl groups in R¹ to R⁴ in the general formula (1). Substituents for the aliphatic hydrocarbon groups and the aryl groups include the same groups as the substituents in R¹ to R⁴.

Among them, R′, R″, R′″ and R″″ preferably include alkyl groups such as methyl, ethyl, propyl, i-propyl, i-butyl, n-butyl, n-hexyl and cyclohexyl; haloalkyl groups such as trichloromethyl and trifluoromethyl; phenyl; aralkyl groups such as benzyl and phenethyl.

Those represented by the general formula (2) where no salt is formed is more preferable in terms of solubility in various solvents than those represented by the general formula (A) or the general formula (B) where the salt has been formed.

Specific examples of the compound represented by the general formula (2) include, but are not limited to, for example, those exemplified below.

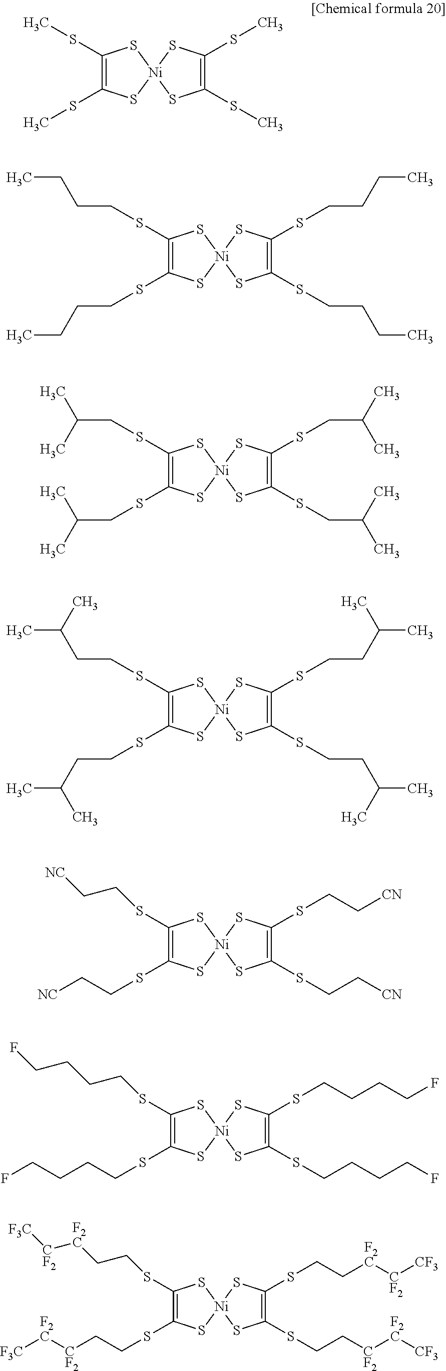

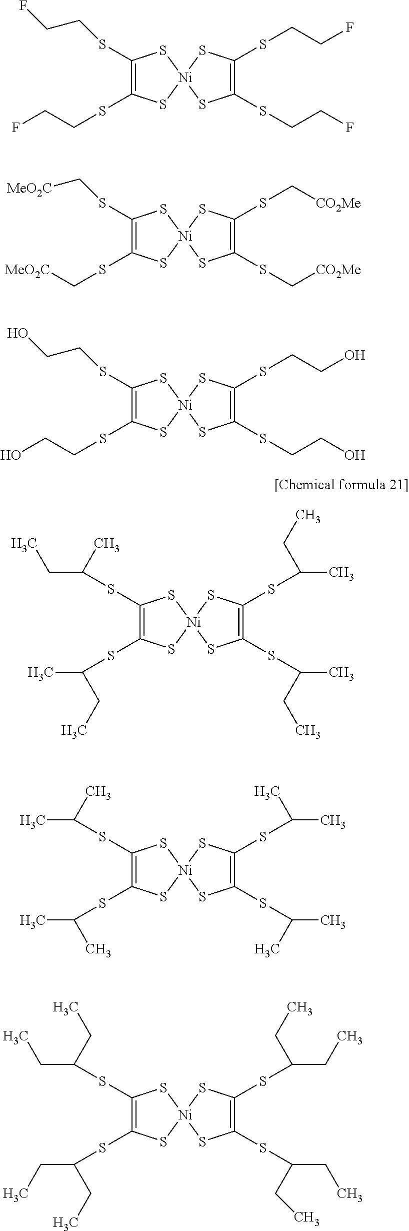

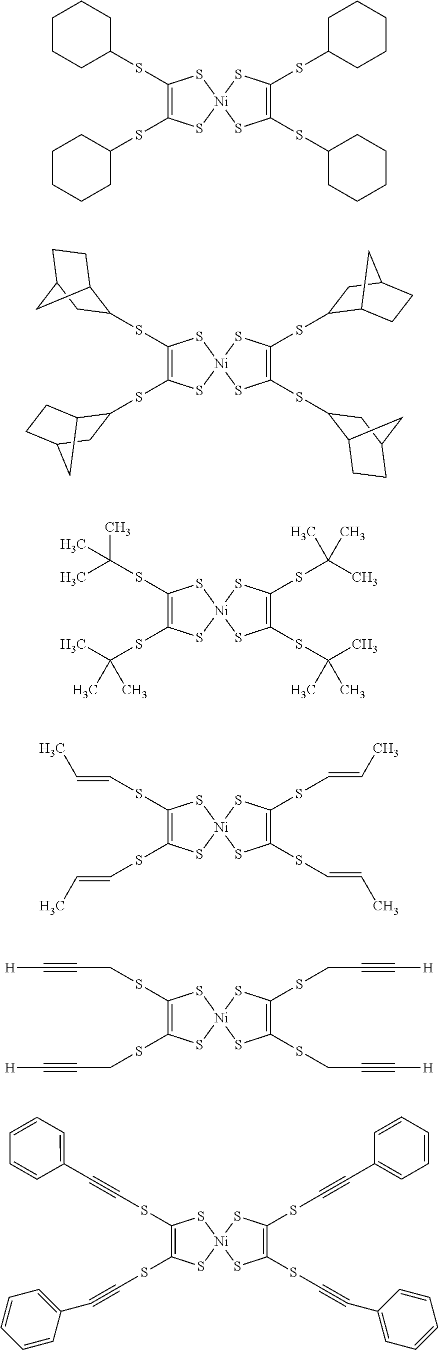

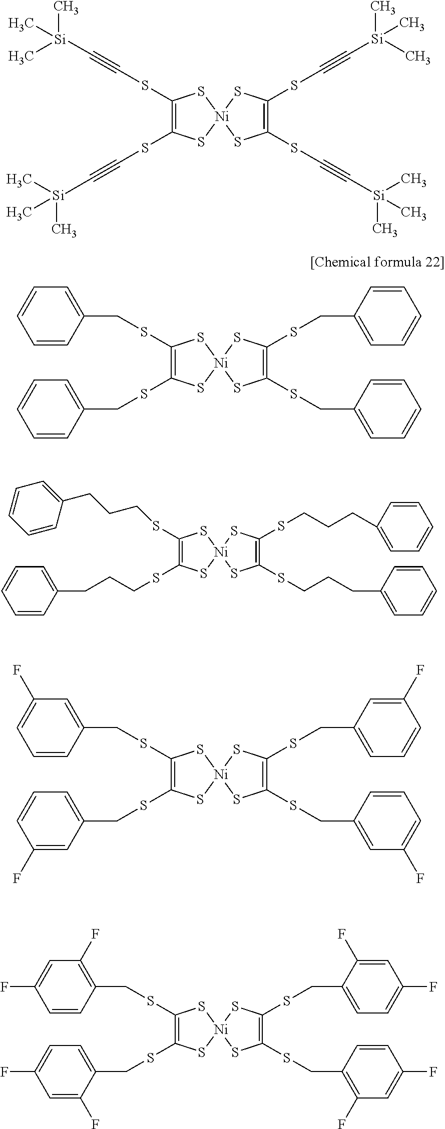

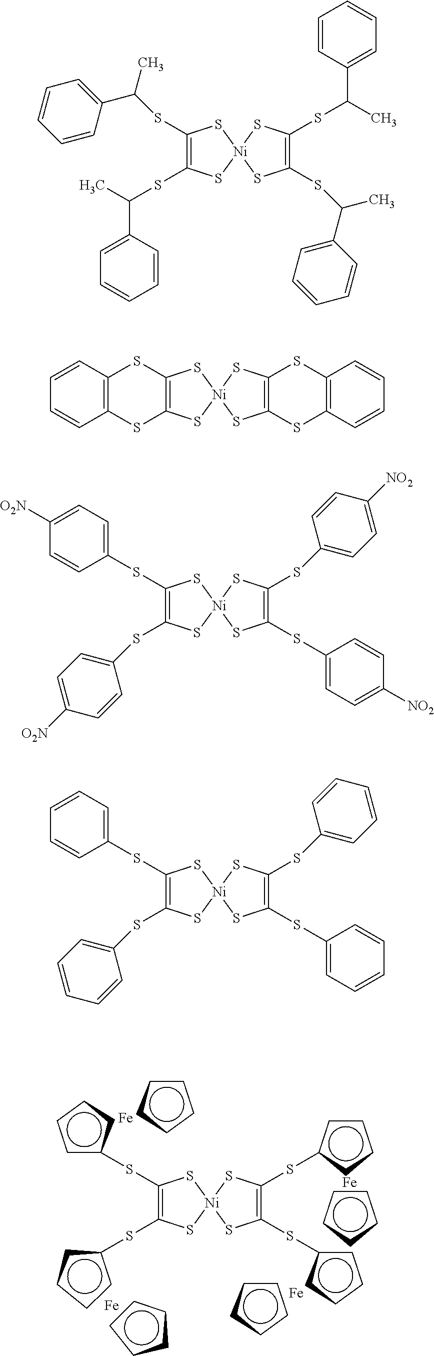

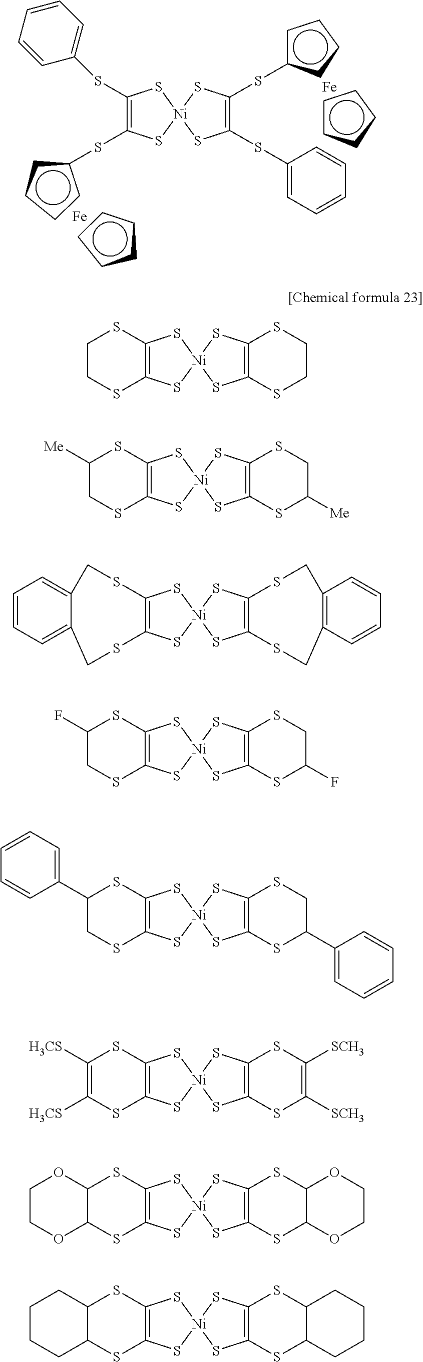

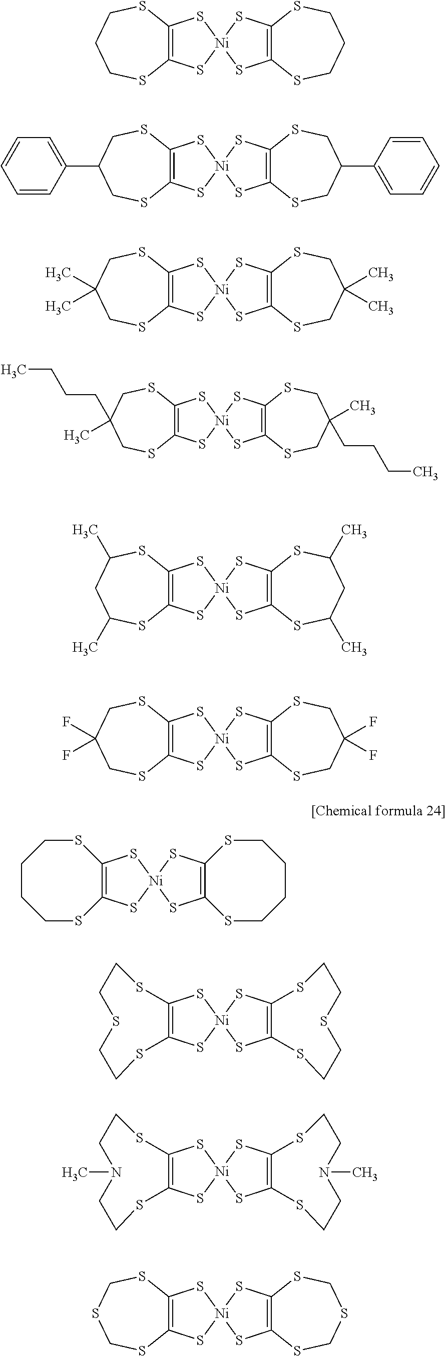

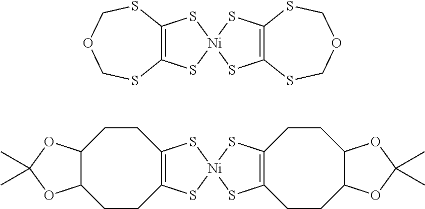

It is essential that the near infrared light absorbable dye composition of the present invention further comprises a compound represented by the following general formula (3):

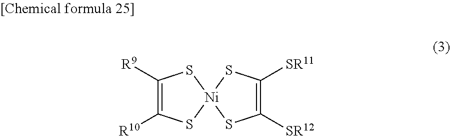

wherein R⁹ and R¹⁰ represent R¹ and R² or represent R³ and R⁴ in the general formula (1), and R¹¹ and R¹² represent R⁵ and R⁶ or represent R⁷ and R⁸ in the general formula (2).

R⁹ and R¹⁰ in the general formula (3) represent the same organic groups as R¹ and R² in the general formula (1), or also represent the same organic groups as R³ and R⁴. Preferable ones are the same. The substituents are the same, and the preferable substituents are also the same. R¹¹ and R¹² in the general formula (3) represent the same organic groups as R⁵ and R⁶ in the general formula (1), or also represent the same organic groups as R⁷ and R⁸. Preferable ones are the same. The substituents are the same, and the preferable substituents are also the same. The compound represented by the general formula (3) may become the salt type compound aforementioned in the section for the compound represented by the general formula (2). In the case of the salt type compound, preferable XR′R″R′″R″″ is the same as in the case of the compound represented by the general formula (2). Here, X represents the group-15 atom, and R′R″, R′″ and R″″ each independently represent aliphatic hydrocarbon groups which may have the substituent or aryl groups which may have the substituent.

The specific compounds represented by the general formula (3) include the compounds combining R¹ and R², R³ and R⁴ which are the specific compounds represented by the above general formula (1) with R⁵ and R⁶, R⁷ and R⁸ which are the specific compounds represented by the above general formula (2).

As long as the near infrared light absorbable dye composition of the present invention contains the compound represented by the above general formula (1), the compound represented by the above general formula (2) and the compound represented by the above general formula (3) as the essential components, the method for producing it is not particularly limited, but it is preferable that the compound represented by the above general formula (3) is synthesized by mixing the compound represented by the above general formula (1) and the compound represented by the above general formula (2) in the solution. Furthermore, it is particularly preferable to contain the compound represented by the above general formula (3) synthesized by mixing the compound represented by the above general formula (1) and the compound represented by the above general formula (2) in the solution and progressing exchange reactions of R¹ to R⁸ to come to an equilibrium state. It is particularly preferable in terms of cost saving that the total amount of the compound represented by the above general formula (3) is synthesized by mixing the compound represented by the above general formula (1) and the compound represented by the above general formula (2) in the solution and progressing the exchange reactions.

If the compound represented by the above general formula (3) is synthesized as above, a number of steps is reduced and the labor hour and the cost upon the production can be reduced. When the compound represented by the above general formula (1) and the compound represented by the above general formula (2) are simply blended so as to have the absorption in the wide range of 800 to 1100 nm and the compound represented by the above general formula (3) is not contained (or the compound represented by the above general formula (3) is not synthesized), the durability is deteriorated, the color fading occurs and the near infrared light can not be shield in some cases. Thus, it is preferable to synthesize the compound represented by the above general formula (3) by the exchange reaction by mixing the compound represented by the general formula (1) and the compound represented by the general formula (2) as above.

When the compound represented by the general formula (3) is synthesized by the exchange reaction by mixing the compound represented by the general formula (1) and the compound represented by the general formula (2), their mixed ratio is not particularly limited, but preferably the range of “20 parts by mass of the compound represented by the general formula (1)/80 parts by mass of the compound represented by the general formula (2)” to “80 parts by mass of the compound represented by the general formula (1)/20 parts by mass of the compound represented by the general formula (2)” is preferable.

The near infrared light absorbable dye composition solution in which the near infrared light absorbable dye composition prepared by mixing the solution of the compound represented by the general formula (1) and the solution of the compound represented by the general formula (2) has been dissolved is preferable because the near infrared light absorbable dye-containing pressure sensitive adhesive and the near infrared light absorbable filter obtained therefrom have the effects of the present invention. The near infrared light absorbable dye composition solution obtained by mixing the compound represented by the general formula (1) and the compound represented by the general formula in the range at a mass ratio of 1:4 to 4:1 in the solution is more preferable.

Particularly preferable is the range of “30 parts by mass of the compound represented by the general formula (1)/70 parts by mass of the compound represented by the general formula (2)” to “70 parts by mass of the compound represented by the general formula (1)/30 parts by mass of the compound represented by the general formula (2)”. When they are in this range, the appropriate amount of the compound represented by the general formula (3) is synthesized, and the ratio of the compound represented by the general formula (1)/the compound represented by the general formula (2)/the compound represented by the general formula (3) becomes suitable to absorb the light in the wide range of 800 to 1100 nm.

When the compound represented by the general formula (3) is synthesized by the exchange reactions by mixing the compound represented by the general formula (1) and the compound represented by the general formula (2) in the solvent, their reaction temperature is not particularly limited, but is preferably a boiling point or below of the solvent to be used. The reaction temperature is preferably 10 to 150° C. and particularly preferably 30 to 120° C. Their reaction time period is not particularly limited, and is preferably 30 minutes to 48 hours and particularly preferably 1 to 24 hours depending on the reaction temperature.

The solvent used for the exchange reaction is not particularly limited as long as its solubility is sufficient, and specifically includes, for example, halogenated aliphatic hydrocarbons such as 1,2,3-trichloropropane, tetracholoethylene, 1,1,2,2-tetrachloroethane and 1,2-dichloroethane; alcohols such as methanol, ethanol, propanol, butanol, pentanol, hexanol, cyclohexanol and octanol; ketones such as acetone, methyl ethyl ketone and methyl isobutyl ketone; esters such as ethyl acetate, methyl propionate, methyl enanthate, methyl linoleate and methyl stearate; aliphatic hydrocarbons such as cyclohexane, hexane and octane; aromatic hydrocarbons such as benzene, toluene, xylene, mesitylene, monochlorobenzene, dichlorobenzene, nitrobenzene and squalane; sulfoxides such as dimethylsulfoxide and sulfolane; amides such as N,N-dimethylformamide and N,N,N′,N′-tetramethylurea; and ethers such as tetrahydrofuran, dioxane, dimethoxyethane, diethylene glycol dimethyl ether, triethylene glycol dimethyl ether and tetraethylene glycol dimethyl ether. These can be used alone or in mixture of two or more.

It is also preferable for reducing the number of steps that the near infrared light absorbable dye composition solution obtained by the exchange reaction as above can directly dissolve a binder resin to use as a coating solution for preparing a near infrared light absorbable dye layer described later.

It is preferable that either one of the compound represented by the general formula (1) or the compound represented by the general formula (2) has the maximum absorption wavelength of 750 to 950 nm and the other one has the maximum absorption wavelength of 900 to 1200 nm. By blending at least two of such compounds, it is possible to produce the compound represented by the general formula (3) to make the mixture of three types and cut the light in the wide range in the near infrared light region around 800 to 1100 nm.

It is more preferable that the maximum absorption wavelength of the compound represented by the general formula (3) is present between the maximum absorption wavelength of the compound represented by the general formula (1) and the maximum absorption wavelength of the compound represented by the general formula (2). It is particularly preferable that the compound represented by the general formula (3) prepared by mixing the compound represented by the general formula (1) and the compound represented by the general formula (2) having the above maximum absorption wavelength in the solution has the maximum absorption wavelength of 850 to 1000 nm. In this way, the near infrared light absorbable dye composition which diminishes the number of steps upon the production, can reduce the labor hour and the cost upon the production, has high absorption in the wide range of 800 to 1100 nm and is not deteriorate in the durability by blending is obtained.

A molar absorption coefficient of the compounds represented by the general formula (1), the general formula (2) and the general formula (3) is preferably 5000 Lcm⁻¹ mol⁻¹ or more and particularly preferably 8000 Lcm⁻¹ mol⁻¹ or more at each maximum absorption wavelength. Their solubility in aromatic hydrocarbon-based solvents such as toluene, ether-based solvents such as tetrahydrofuran and dimethoxyethane, and ketone-based solvents such as methyl ethyl ketone is preferably 0.1% by mass or more and particularly preferably 0.5% by mass or more in terms of economical efficiency.

The contents of the compounds represented by the general formulae (1), (2) and (3) in the near infrared light absorbable dye composition are not particularly limited, but it is preferable that the content of the compound represented by the general formula (3) is preferably 20% by mass or more, more preferably 30% by mass or more and particularly preferably 35% by mass or more based on the total amount of the near infrared light absorbable dye composition composed of the compounds represented by the general formulae (1), (2) and (3).

Using the compound represented by the following formula (1-a) as the example of the compound represented by the general formula (1), the compound represented by the following formula (2-a) as the example of the compound represented by the general formula (2), and the compound represented by the following formula (3-a) as the example of the compound represented by the general formula (3), preferable blended examples will be shown below, but the present invention is not limited to the following specific examples.

<Preferable Range>
3 to 60 parts by mass of the compound represented by the general formula (1-a),
7 to 80 parts by mass of the compound represented by the general formula (2-a) and
20 to 80 parts by mass of the compound represented by the general formula (3-a).

<More Preferable Range>
5 to 50 parts by mass of the compound represented by the general formula (1-a),
10 to 60 parts by mass of the compound represented by the general formula (2-a) and
25 to 70 parts by mass of the compound represented by the general formula (3-a).

<Particularly Preferable Range>
25 to 50 parts by mass of the compound represented by the general formula (1-a),
10 to 60 parts by mass of the compound represented by the general formula (2-a) and
30 to 65 parts by mass of the compound represented by the general formula (3-a).

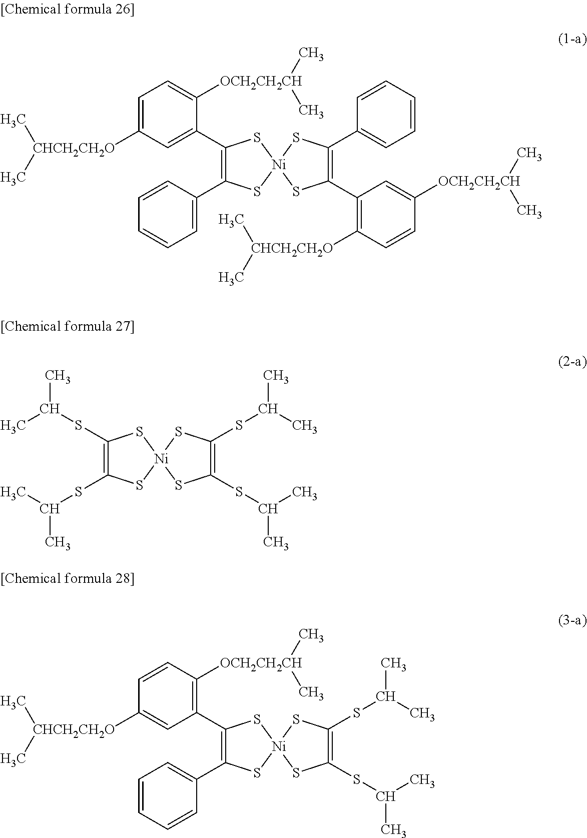

### <Near Infrared Light Absorbable Filter>

The constitution of the near infrared light absorbable filter and the method for producing the near infrared light absorbable filter by applying the solution containing the near infrared light absorbable dye composition on a transparent substrate will be described in detail below.

### (Substrate)

The transparent substrate which constitutes the near infrared light absorbable filter of the present invention is not particularly limited as long as it is substantially transparent, the absorption and scatter are not large. Specific examples thereof include glasses, polyolefin-based resins, amorphous polyolefin-based resins, polyester-based resins, polycarbonate-based resins, poly(meth)acylate ester-based resins, polystyrene, polyvinyl chloride, polyvinyl acetate, polyallylate resins and polyether sulfone resins. Among them, amorphous polyolefin-based resins, polyester-based resins, polycarbonate-based resins, poly(meth)acrylate ester-based resins, polyallylate resins and polyether sulfone resins are particularly preferable. These resins can blend publicly known additives such as phenol-based or phosphorous-based antioxidants, halogen-based or phosphate-based flame retardants, anti-heat anti-aging agents, ultraviolet light absorbers, lubricants and antistatic agents.

As the transparent substrate, those obtained by molding these resins into a film shape using a molding method such as an injection molding method, a T die molding method, a calendar molding method or a compression molding method, or a method of dissolving in the organic solvent and casting are used. The resin molded into the film shape may be streched or not streched. Furthermore, the film composed of the different material may be stacked. A thickness of the transparent substrate is typically selected from the range of 10 μm to 5 mm depending on the purpose. Furthermore, a surface treatment by a conventional method such as a corona discharge treatment, a flame treatment, a plasma treatment, a glow discharge treatment, a roughening treatment and a chemical treatment, or coating with an anchor coating agent or a primer may be given to the transparent substrate.

### (Coating Solution)

A coating solution containing the near infrared light absorbable dye composition can be prepared by dissolving or dispersing the near infrared light absorbable dye composition if necessary together with a binder in the solvent. When dispersed, the near infrared light absorbable dye composition can also be finely granulated so as to typically have a particle diameter of 0.1 to 3 μm and dispersed if necessary using a dispersant together with the binder. At that time, a concentration of a total solid content of the near infrared light absorbable dye composition, the dispersant the binder and the like is typically 5 to 50% by mass based on the entire solution. The concentration of the near infrared light absorbable dye composition is typically 0.1 to 50% by mass and preferably 0.2 to 30% by mass based on the total solid content. The concentration of the near infrared light absorbable dye composition relative to the binder, as the matter of course, also depends on a film thickness of the near infrared light absorbable filter, and thus is lower than the aforementioned concentration when the composition is melted and kneaded to mold into the film shape.

The dispersant includes polyvinyl butyral resins, phenoxy resins, rosin modified phenol resins, petroleum resins, cured rosin, rosin ester, maleinated rosin and polyurethane resins. Its amount to be used is typically 0 to 100% by mass and preferably 0 to 70% by mass based on the amount of the metal complex compound.

The binder typically includes polymethyl methacrylate resins, polyethyl acrylate resins, polycarbonate resins, ethylene-vinyl alcohol copolymer resins and polyester resins. For its amount to be used, the amount of the metal complex compound is typically 0.01% by mass or more, preferably 0.1% by mass or more, typically 20% by mass or less and preferably 10% by mass or less based on the amount of the binder.

As the binder used for the near infrared light absorbable filter in the case of containing the compounds selected from the group consisting of the compounds represented by the general formulae (1), (2) and (3) and the salt type compounds thereof, the binder having a moisture absorption rate of 2% or less at a temperature of 60° C. and a humidity of 90% is preferable. Such a binder is not particularly limited as long as the moisture absorption rate is 2% or less at the temperature of 60° C. and the humidity of 90%. The ordinary binder is appropriately selected and used, but polymethyl methacrylate, polycarbonate, polystyrene, polyallylate, polyethylene terephthalate and polyester are effectively used because they have the high solubility in the organic solvent. These binders may be used alone or in mixture of two or more.

A weight average molecular weight of these binders is typically 1,000 or more, preferably 5,000 or more, more preferably 10,000 or more, and typically one million or less, preferably 0.5 million or less and more preferably 0.3 million or less. When the weight average molecular weight is small, the moisture absorption rate tends to increase in the polymer binder having a hydrophilic substituent at a terminus. When the weight average molecular weight is large, there is a tendency that the solubility in the organic solvent becomes low and its handling becomes complicated.

An acid value of the binder is typically 10 mg KOH/g or less, preferably 5 mg KOH/g or less, more preferably 2 mg KOH/g or less and particularly preferably 0 mg KOH/g. When the acid value of the binder is too large, the moisture absorption rate tends to increase, and when the acid value is too small, the moisture absorption rate tends to decrease. Thus, it is preferable that the acid value is small as possible. The acid value of the binder is defined as a measured value when the binder is dissolved in ethanol, subsequently a neutralization titration is performed with a KOH solution, and a consumed amount (mg) of KOH (potassium hydroxide) per 1 g of the binder is measured.

In the present invention, as the binder having the low moisture absorption rate, those in which the amount of the hydrophilic substituents such as hydroxyl, carboxyl and sulfonyl groups is small are preferable. The acid value is correlated with the amount of the hydrophilic substituent. Thus, when the acid value of the binder is small, the hydrophilicity of the binder is lowered. As a result, the moisture absorption rate tends to decrease. Thus, this is preferable.

In the present invention, the moisture absorption rate of the polymer binder at the temperature of 60° C. and humidity of 90% (hereinafter sometimes abbreviated as the “moisture absorption rate at 60° C. and 90%”) is obtained by leaving the polymer binder in the thermo-hygrostat for a predetermined time period, measuring its weight, obtaining the change of its weight, confirming that the change of its weight has been substantially stopped (e.g., 0.05% per day), and calculating by the following formula from the heaviest weight W₁ and the initial weight (dry weight) W₀. W₁ is measured after leaving stand in the thermo-hygrostat for one week.

“Moisture absorption rate at 60° C. and 90%”=100×(W₁−W₀)/W₀

In the present invention, when the “moisture absorption rate at 60° C. and 90%” of the binder to be used exceeds 2%, the sufficient heat resistance, wet resistance and light resistance can not be obtained. The lower the “moisture absorption rate at 60° C. and 90%” is the more preferable. In particular it is preferable to be 1.5% or less and especially to be 1% or less.

As the solvent, the same ones as those used for the near infrared light absorbable dye composition solution are preferably used.

### (Near Infrared Light Absorbable Dye Composition-Containing Pressure Sensitive Adhesive and Near Infrared Light Absorbable Filter Using the Same)

It is preferable that the aforementioned coating solution containing the near infrared light absorbable dye composition takes the form as the pressure sensitive adhesive. That is, the pressure sensitive adhesive containing the near infrared light absorbable dye composition, and the pressure sensitive adhesive obtained from the solution containing the near infrared light absorbable dye composition are suitably used for producing the near infrared light absorbable filter.

The near infrared light absorbable dye composition-containing pressure sensitive adhesive can be prepared by dissolving or dispersing the near infrared light absorbable dye together with the binder in the solvent. When dispersed, it is also possible to prepare by finely granulating the near infrared light absorbable dye so as to typically have the particle diameter of 0.1 to 3 μm and dispersing it together with the binder if necessary using the dispersant in the solvent.

The types of the dispersant and the binder dissolved or dispersed in the solvent, their concentrations and the total solid content concentration are the same as those described above.

Coating of the near infrared light absorbable dye composition-containing pressure sensitive adhesive onto the transparent substrate is performed by a publicly known coating method such as a dipping method, a flow coating method, a spray method, a bar coating method, a gravure coating method, a roll coating method a blade coating method or an air knife coating method. The near infrared light absorbable dye composition-containing pressure sensitive adhesive is applied so that the film thickness after drying is typically 0.1 μm or more, preferably 0.5 μm or more, typically 5000 μm or less, preferably 1000 μm or less and more preferably 100 μm or less.

In particular, when used as the pressure sensitive adhesive for electric displays, it is required that the transparency is high. Also in terms of flatness and working efficiency, the near infrared light absorbable dye composition-containing pressure sensitive adhesive is applied so that its film thickness after drying is typically 1 μm or more, preferably 5 μm or more, more preferably 10 μm or more, and typically 200 μm or less, preferably 100 μm or less and more preferably 50 μm or less.

### (Ultraviolet Light Protection Layer)

The near infrared light absorbable filter of the present invention can remarkably enhance its light resistance by a synergistic effect with the near infrared light absorbable dye (metal complex) by further providing an ultraviolet light protection layer. The ultraviolet light protection layer is one which can efficiently cut off the ultraviolet light having the wavelength of 400 nm or less, and preferably can absorb 70% of the light having the wavelength of 350 nm. The type of the ultraviolet light protection layer is not particularly limited, but a resin film containing an ultraviolet light absorber (UV protection film) is preferable.

The ultraviolet absorber used for the ultraviolet protection layer is not particularly limited as long as it has the maximum absorption between 300 and 400 nm and efficiently cuts off the light in that region, and organic and inorganic compounds can be used. For example, the organic ultraviolet light absorber includes benzotriazole-based ultraviolet light absorbers, benzophenone-based ultraviolet light absorbers, salicylate ester-based ultraviolet light absorbers, triazine-based ultraviolet light absorbers, para-aminobenzoic acid-based ultraviolet light absorbers, cinnamic acid-based ultraviolet light absorbers, acrylate-based ultraviolet light absorbers and hindered amine-based ultraviolet light absorbers. The inorganic ultraviolet light absorber includes titanium oxide-based ultraviolet light absorbers, zinc oxide-based ultraviolet light absorbers and microparticle iron oxide-based ultraviolet light absorbers. However, since the inorganic ultraviolet light absorber is present in a microparticle state in the ultraviolet light protection layer, the efficiency of the near infrared light absorbable filter is likely to be impaired. Thus, the organic ultraviolet light absorber is preferable.

Such an ultraviolet light absorber includes, for example, TINUBIN P, TINUBIN 120, 213, 234, 320, 326, 327, 328, 329, 384, 400 and 571 supplied from Ciba-Geigy, SUMISORB 250, 300 and 577 supplied from Sumitomo Chemical Co. Ltd., VIOSORB 582, 550 and 591 supplied from Kyodo Chemical Co. Ltd., JF-86, 79, 78 and 80 supplied from Johoku Chemical Co. Ltd., ADKSTAB LA-32, LA-36 and LA-34 supplied from Asahi Denka Co. Ltd., SEESORB 100, 101, 101S, 102, 103, 501, 201, 202 and 612NH supplied from Shipro Kasei Co. Ltd., RUVA 93, 30M and 30S supplied from Otsuka Chemical Co. Ltd., and UVINUL 3039 supplied from BASF. These ultraviolet light absorbers may be used alone or in combination of several types. Fluorescent whiting agents such as UVITEX OB and OB-P supplied from Ciba-Geigy which absorb the ultraviolet light and convert its wavelength to the visible region can also be used.

As the ultraviolet protection film, commercially available UV protection filters can also be used, and include, for example, SC-38, SC-39 and SC-42 supplied from Fuji Film Corporation, and ACRYPLEN supplied from Mitsubishi Rayon Co. Ltd. The above UV protection filters, both SC-39 and ACRYPLEN are the ultraviolet light protection films which absorb 99% or more of the light having the wavelength of 350 nm.

In the near infrared light absorbable filter of the present invention provided with the ultraviolet light absorption layer in this way, a residual dye rate after a light resistance test by exposing to a Xe lamp for 200 hours is 80% or more, preferably 85% or more and particularly preferably 90% or more, and no new absorption peak appears in the visible light region. Here, the residual dye rate is obtained by a reduced level of an absorption intensity before and after the test in the 800 to 1050 nm region.

The above near infrared light absorbable filter may be obviously used alone, and may also be used as a laminated body by laminating to the transparent glass or another transparent resin plate. The near infrared light absorbable filter obtained according to the present invention can be used in a wide variety of application fields such as heat ray shielding films, sunglasses, protection glasses and remote receivers in addition to the filters for the display panels. Furthermore, the near infrared light absorbable filter of the present invention can be provided with an electromagnetic wave protection layer, an anti-reflection layer which prevents outside light such as fluorescent light from reflecting off on the surface, an antiglare layer (non-glare layer) and a color correction layer to use as the filter for the electronic devices, more preferably the plasma display panels.

When the near infrared light absorbable filter of the present invention is used as the filter for the electronic device, its constitution and the method for producing it are not particularly limited and the constitution and the method typically used can be employed. The case of using as the filter for the plasma display panel will be described below as a representative example.

### (Electromagnetic Wave Protection Layer)

The electromagnetic wave protection layer used in the filter for the plasma display panel can be obtained by depositing or sputtering the metal oxide and the like. Typically, indium tin oxide (ITO) is common, but the light at 1,000 nm or more can be cut off by alternately stacking the dielectric layers and the metal layers by sputtering on the substrate. As the dielectric layer, the transparent metal oxide such as indium oxide or zinc oxide is used, and as the metal layer, silver or silver-palladium alloy is common. Typically about 3 layers, 5 layers, 7 layers or 11 layers are stacked from the dielectric layer. As the substrate, the near infrared light absorbable filter of the present invention may be directly utilized, or the electromagnetic wave protection layer is provided on the resin film or the glass by deposit or sputtering, which may be then laminated to the near infrared light absorbable filter of the present invention.

### (Anti-Reflection Layer)

As the anti-reflection layer used in the filter for the plasma display panel of the present invention, in order to prevent the reflection on the surface and enhance the transmittance in the filter, metal oxide or inorganic substances such as fluoride, silicide, boride, carbide, nitride and sulfide are stacked in a single layer or multiple layers by a vacuum deposit method, a sputtering method, an ion plating method or an ion beam assist method, or the resins such as acrylic resin and fluorine resin which have the different refractive index are stacked in the single layer or the multiple layers. The film to which an anti-reflection treatment has been given can also be laminated with the filter.

The common near infrared light absorbable filters including the near infrared light absorbable filter of the present invention often becomes slightly greenish. In the case of being used for the display such as the plasma display, it is preferable that its color is achromatic. Thus it is preferable that a color material having the absorption at 500 to 600 nm to become a complementary color of a green color is contained to make achromatic to an extent that the luminance of the display is not largely impaired.

In electric light bulbs and halogen bulb electric lamps, the amount of red components in their emission spectrum is large. Thus, the color under lighting by the fluorescent light looks like the achromatic color, but the color under these lightings often becomes reddish. In such a case, it is preferable that the color even under the electric light bulb and the halogen bulb electric lamp is also made achromatic by containing the color material having the absorption at around 600 to 700 nm to the extent that the luminance of the display is not largely impaired.

Furthermore, in the case of being used as the filter for the plasma display, it is more preferable to compensate the color by containing the color material which can absorb a neon orange light at 590 to 600 nm emitted from the plasma display. The layer containing these dyes may be made as a different layer from a near infrared light absorbable layer and laminated to the near infrared light absorbable layer to make a laminated body, or may be made in the same layer of the near infrared light absorbable agent if there is no problem in various properties such as color development and durability when mixed with the near infrared light absorbable agent. But, the latter is preferable in terms of step simplification and cost saving.

The color materials used here include common color materials such as inorganic pigments, organic pigments, and organic dyes and coloring matters. The inorganic pigments include cobalt compounds, iron compounds and chromium compounds. The organic pigments include azo-based, indolinone-based, quinacridone-based, butt-based, phthalocyan-based and naphthalocyan-based pigments. The organic dyes and coloring matters include azine-based, azo-based, nickel azo complex-based, azomethine-based, anthraquinone-based, indigoid-based, indoaniline-based, oxazine-based, oxonole-based, xantene-based, quinophtalone-based, cyanine-based, squarylium-based, stilbene-based, tetraazaporphyrin-based, triphenylmethane-based, naphthoquinone-based, pyralozone-based, pyrromethene-based, dipyrromethene-based, benzylidene-based, polymethine-based, methine-based and chromium complex salt-based dyes and coloring matters.

Specific examples of the color material which has the absorption at 500 to 600 nm and becomes the complementary color of the green color include AIZEN S.O.T. Violet-1, AIZEN S.O.T. Blue-3, AIZEN S.O.T. Pink-1, AIZEN S.O.T. Red-1, AIZEN S.O.T. Red-2, AIZEN S.O.T. Red-3, AIZEN Spilon Red BEH Special and AIZEN Spilon Red GEH Special supplied from Hodogaya Chemical Co., Ltd., Kayaset Blue A-S, Kayaset Red 130, Kayaset Red A-G, Kayaset Red 2G, Kayaset Red BR, Kayaset Red SF-4G, Kayaset Red SF-B and Kayaset Violet A-R supplied from Nippon Kayaku Co., Ltd., DIAREZIN Blue-J, DIAREZIN Blue-G, DIAREZIN Violet-D, DIAREZIN Red H5B, DIAREZIN Red S, DIAREZIN Red A, DIAREZIN Red K, DIAREZIN Red Z and PTR63 supplied from Mitsubishi Chemical Corporation, Violet-RB, Red-G, Pink-5BGL, Red-BL, Red-2B, Red-3GL, Red-GR and Red-GA supplied from Ciba Specialty Chemicals. Among them, when the color material is contained in the same layer as the near infrared light absorbable agent, the chromium complex salt-based color material is preferable in terms of stability of the near infrared light absorbable agent.

Specific examples of the color material having the absorption at around 600 to 700 nm include AIZEN S.O.T. Blue-l, AIZEN S.O.T. Blue-2, AIZEN S.O.T. Blue-3, AIZEN S.O.T. Blue-4, AIZEN Spilon Blue 2BNH and AIZEN Spilon Blue GNH supplied from Hodogaya Chemical Co., Ltd., Kayaset Blue N, Kayaset Blue FR and KAYASORB IR-750 supplied from Nippon Kayaku Co., Ltd., DIAREZIN Blue-H3G, DIAREZIN Blue-4G, DIAREZIN Blue-LR PTB31, PBN, PGC, KBN and KBFR supplied from Mitsubishi Chemical Corporation, and Blue-GN, Blue-GL, Blue-BL, Blue-R and C.I. Solvent Blue 363 supplied from Ciba Specialty Chemicals.

Specific examples of the color materials having the absorption at 560 to 600 nm include the organic dyes described in JP 2000-258624-A Publication, JP 2002-040233-A Publication and JP 2002-363434-A Publication, and organic pigments such as quinacridone described in JP 2004-505157 Publication and JP 2004-233979-A Publication.

### (Non-Glare Layer)

The antiglare layer (non-glare layer) may be provided in addition to the above respective layers. The non-glare layer is obtained by making a powder body of silica, melamine or acryl an ink and coating it on the surface in order to scatter the transmitted light for the purpose of extending a view angle of the filter. The ink can be cured by thermal curing or light curing. The film to which a non-glare treatment has been given can also be laminated with the filter. Furthermore, a hard coating layer can also be provided if necessary.

<Physical Property of Near Infrared Light Absorbable Filter of the Present Invention>

One of the durability required as the filter for the electronic devices is the light resistance. It is practically extremely important that the filter is not deteriorated by emitted light, irradiation lights from the electronic display and environmental lights which enter the electronic device.

The following is an indicator of a performance physical property for the light resistance. The filter is irradiated with xenon light at an irradiation intensity of 0.55 W/m² at a wavelength of 340 nm, 38 W/m² at a wavelength of 420 nm, 64.5 W/m² at a wavelength of 300 to 400 nm and 605.4 W/m² at a wavelength of 300 to 800 nm in the state where the UV light is cut off for 160 hours. Subsequently, absorption intensities before and after the irradiation are compared at the maximum absorption wavelength before the irradiation. Then, the rate calculated by “Absorption intensity after irradiation/Absorption intensity before irradiation×100” is practically required to be 50% or more, is preferably 60% or more, more preferably 70% or more and still more preferably 80% or more.

The wavelength at which the absorption intensity is measured is not particularly limited, and includes 800 to 1100 nm at which the performance as the near infrared light absorbable filter for the electronic device can be maximally exerted. More preferably it is also included that the change is small at 350 to 800 nm which is the visible light region because it is practically required that the filter for the electronic device has no color change. When a visible light absorbable dye is also contained in the pressure sensitive adhesive of the present invention to give a control function in the visible light region, it is effective as the filter for the electronic device that the change at the maximum absorption wavelength at which the function is exerted is smaller and the residual rate is larger.

Having the heat resistance in addition to the light resistance is effective for reducing the deterioration during the storage and the transport. Furthermore, this is effective for using for directly adhereing to the panel of the electronic device. For example, in the plasma display panel (PDP) which has been noticed as one of the electronic devices, in recent years, a directly adhereing system in which the filter having the function of a front glass filter is directly laminated to the panel to enhance the image by elimination of reflected image reflection off, simplify the process by reducing the member number and lighten by elimination of the glass has been proposed. However, in this system, the heat from the panel is directly transmitted to the filter itself for the electronic device. Thus, the higher heat resistance is needed compared with the conventional system in which a space is present between the front glass filter and the electronic display panel.

The following is the indicator of the performance physical property for the heat resistance. The filter is exposed to the environment at a temperature of 80° C. for 250 hours, and the absorption intensities before and after the exposure are compared at the maximum absorption wavelength before the exposure. Then, the rate calculated by “Intensity after exposure/Absorption before exposure×100” is practically required to be 50% or more and is more preferably 80% or more.

More preferably it is practically required that the rate in the exposure for 500 hours is 50% or more and more preferably 80% or more. The wavelength at which the absorption intensity is measured is the same as in the case of measuring the light resistance.

For the more preferable heat resistance, the filter is exposed to the environment at the temperature of 90° C. for 250 hours, and the absorption intensities before and after the exposure are compared at the maximum absorption wavelength before the exposure. Then, the rate calculated by “Absorption intensity after exposure/Absorption intensity before exposure×100” is practically required to be 50% or more and is more preferably 80% or more.

Having the wet heat resistance is very effective not only for enhancing practical resistance properties and reliability but also reducing the deterioration in the transport by ship and in the storage. Heavy export products are transported by ship, and storage locations near a ship bottom becomes the environment with extremely high humidity.

The following is the indicator of the performance physical property for the wet heat resistance. The filter is exposed to the environment at the temperature of 60° C. and a relative humidity of 90% for 250 hours, and the absorption intensities before and after the exposure are compared at the maximum absorption wavelength before the exposure. Then, the rate calculated by “Absorption intensity after exposure/Absorption intensity before exposure×100” is practically required to be 50% or more, and more preferably the rate is 80% or more.

More preferably it is practically required that the rate in the exposure for 500 hours is 50% or more, and more preferably the rate is 80% or more. The wavelength at which the absorption intensity is measured is the same as in the case of measuring the light resistance.

In addition to these durability and reliability, the function to shield the near infrared light at 800 to 1100 nm is required because the light acts upon the electronic instruments such as cordless phones, video cartridge recorders using a near infrared light remote control around there in the wavelength region of 800 to 1100 nm to cause the malfunction. Thus, as a shielding performance, a spectral transmittance at the maximum absorption wavelength is preferably 40% or less, more preferably 20% or less and still more preferably 10% or less in the near infrared light absorbable dye composition-containing pressure sensitive adhesive in the sheet type.

In order to shield the light in the wavelength region of 800 to 1100 nm, this may contain multiple near infrared light absorbable dyes. If one dye can accomplish the spectral transmittance of 40% or less, it is possible to accomplish the more preferable spectral transmittance of 10% or less by containing the multiple dyes.

From the above, the durability required as the filter for the electronic device needs the light resistance. More preferably, the heat resistance and the wet heat resistance are necessary. By these resistance properties, the filter for the electronic device is not only practically usable but also its utilization system is expanded and its practical use range is expanded.

### Examples

Embodiments of the present invention will be described below with reference to Examples, but the present invention is not limited thereto unless otherwise departing from its spirit.

### <Evaluation Method>

Using near infrared light absorbable filters (test piece) obtained in Examples and Comparative Examples, the following aging test was performed, and subsequently, a heat resistance test, a wet heat resistance test 1, the wet heat resistance test 2, a heat resistance test 1 and the heat resistance test 2 were performed. For the measurement of absorption intensities, a transmittance was obtained by measuring a spectral transmission spectrum (using UV-3150 integrating sphere system supplied from Shimadzu Corporation and UV-3600 supplied from Shimadzu Corporation), and the absorption intensity at the particular wavelength or the maximum absorption wavelength of each test piece was calculated from the transmittance.

### <Aging Test>

The test piece was left stand under the condition of a temperature at 24° C. and a humidity at 45% for 7 days or more. The change of the absorption intensity after such a tretament was obtained relative to the absorption intensity before such a treatment, and evaluated by the following criteria to make the “aging test”.

A: No substantial change

B: Change of less than 10% and usable

C: Change of 10% or more and unusable

### <Light Resistance Test>

A UV protection filter (SC-39 supplied from Fuji Photo Film Co., Ltd.) was mounted on the test piece, which was then irradiated for 160 hours using Atlas Weatherometer Ci4000 (supplied from Toyoseiki Co., Ltd.) which was a xenon light resistance tester. Atlas Weatherometer had irradiation intensities of 0.55 W/m² at the wavelength of 340 nm, 1.38 W/m² at the wavelength of 420 nm, 64.5 W/m² at the wavelength of 300 to 400 nm and 605.4 W/m² at the wavelength of 300 to 800 nm, the temperature of a black panel and the humidity were controlled to 58° C. and 50% RH, respectively. The change of the absorption intensity after the light resistance test was obtained relative to the absorption intensity before the light resistance test, and evaluated by the following criteria to make the “light resistance test”.

A: The absorption intensity after the test relative to the absorption intensity before the test was 80% or more.

B: The absorption intensity after the test relative to the absorption intensity before the test was 70% or more and less than 80%.

C: the absorption intensity after the test relative to the absorption intensity before the test was 50% or more and less than 70%

D: The absorption intensity after the test relative to the absorption intensity before the test was less than 50%.

### <Wet Heat Resistance Test 1>

The test piece was placed in the thermo-hygrostat at 60° C. and 90% RH, and exposed for 250 hours and 500 hours. The change of the absorption intensity after the wet heat resistance test was obtained relative to the absorption intensity before the wet heat resistance test, and evaluated by the following criteria to make the “wet heat resistance test 1”.

A: The absorption intensity after the test relative to the absorption intensity before the test was 80% or more.

B: The absorption intensity after the test relative to the absorption intensity before the test was 70% or more and less than 80%.

C: The absorption intensity after the test relative to the absorption intensity before the test was 50% or more and less than 70%

D: The absorption intensity after the test relative to the absorption intensity before the test was less than 50%.

### <Wet Heat Resistance Test 2>

The test piece was placed in the thermo-hygrostat at 60° C. and 90% RH, and exposed for 500 hours. The change of an appearance of the test piece after such a wet heat resistance test relative to an appearance of the test piece before the wet heat resistance test was observed, and evaluated by the following criteria to make the “wet heat resistance test 2”.

B: No change between the appearance of the test piece before the test and the appearance of the test piece after the test was observed.

C: The slight change between the appearance of the test piece before the test and the appearance of the test piece after the test was observed.

D: The large change between the appearance of the test piece before the test and the appearance of the test piece after the test was observed.

### <Heat Resistance Test 1>

The test piece was placed in the thermostat at 80° C. and exposed for 250 hours and 500 hours. The change of the absorption intensity after such a heat resistance test was obtained relative to the absorption intensity before the heat resistance test, and evaluated by the following criteria to make the “heat resistance test 1”.

A: The absorption intensity after the test relative to the absorption intensity before the test was 80% or more.

B: The absorption intensity after the test relative to the absorption intensity before the test was 70% or more and less than 80%.

C: The absorption intensity after the test relative to the absorption intensity before the test was 50% or more and less than 70%

D: The absorption intensity after the test relative to the absorption intensity before the test was less than 50%.

### <Heat Resistance Test 2>

The test piece was placed in the thermostat at 90° C. and exposed for 250 hours. The change of the absorption intensity after such a heat resistance test was obtained relative to the absorption intensity before the heat resistance test, and evaluated by the following criteria to make the “heat resistance test 2”.

A: The absorption intensity after the test relative to the absorption intensity before the test was 80% or more.

B: The absorption intensity after the test relative to the absorption intensity before the test was 70% or more and less than 80%.

C: The absorption intensity after the test relative to the absorption intensity before the test was 50% or more and less than 70%

D: The absorption intensity after the test relative to the absorption intensity before the test was less than 50%.

### Example 1

As a near infrared light absorbable dye composition, 15 mg of a compound represented by the following formula (1-a), 30 mg of a compound represented by the following formula (2-a) and 30 mg of a compound represented by the following formula (3-a) were added to 2.5 g of toluene, and stirred to obtain a solution in which the near infrared light absorbable dye compositions was dissolved. Then, before an exchange reaction of “—S” for Ni took place, 10 g of SK-Dyne 1811L (supplied from Soken Chemical & Engineering Co., Ltd.) which was an acrylic pressure sensitive adhesive and 25 mg of isocyanate-based curing agent L-45 (supplied from Soken Chemical & Engineering Co., Ltd.) were added to this solution and stirred to obtain a near infrared light absorbable dye-containing pressure sensitive adhesive. Air bubbles convolved upon stirring were removed by applying ultrasonic waves or resting to accumulate the bubbles in an upper part. SK-Dyne 1811L (supplied from Soken Chemical & Engineering Co., Ltd.) is the isocyanate-based curing agent having an acid value of 0 mg KOH/g and a hydroxy value of 0.2 mg KOH/g.

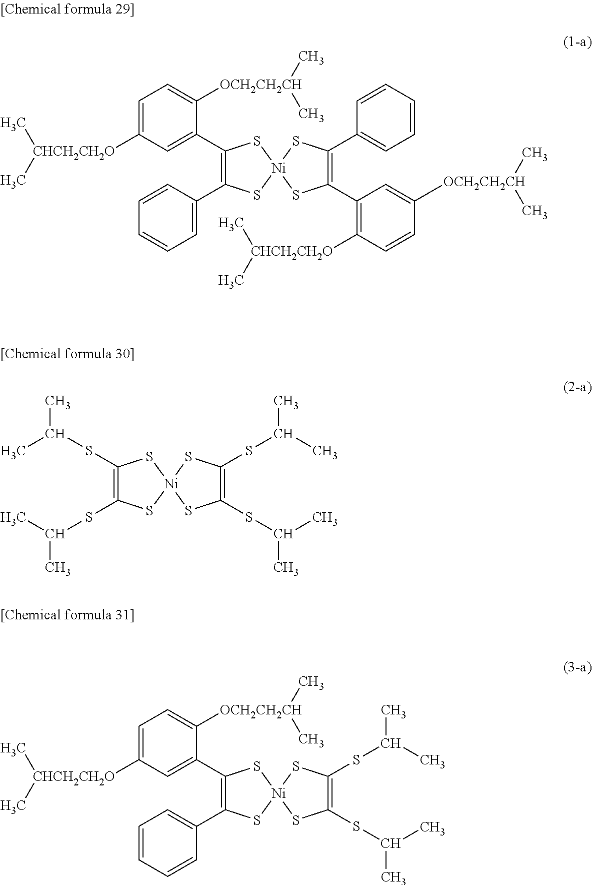

The near infrared light absorbable dye-containing pressure sensitive adhesive at a thickness of 125 μm is coated on a polyethylene terephthalate film having the thickness of 100 μm using Baker type applicator (supplied from Tester Sangyo Co., Ltd.) and dried at 100° C. for two minutes to form an adhesive layer containing a near infrared light absorbable dye composition having the thickness of 25 μm. Then, a polyethylene terephthalate film having the thickness of 100 μm was bonded with pressure on this adhesive layer side using a roller to obtain a near infrared light absorbable filter. A content ratio of the compound of the above (1-a), the compound of the above (2-a) and the compound of the above (3-a) is the same as the above ratio because the exchange reaction did not take place.

This near infrared light absorbable filter has a transmittance of 20% or less at 825 nm, 880 nm and 980 nm, and thus effectively shields the light emitted from the PDP main body.

The above adhesive layer having the thickness of 25 μm and formed on a polyester film was aged at 23° C. for 7 days, and subsequently laminated with a stainless plate. Using this sample, an adhesion strength was measured under an atmosphere at the temperature of 23° C. and the humidity of 65% by a 180 degree peeling method with a tensile speed of 300 mm/minute. The adhesion strength was 850 g/25 mm width.

### Example 2

A near infrared light absorbable dye-containing pressure sensitive adhesive was prepared in the same way as in Example 1, except that 34 mg of the above compound (1-a), 12 mg of the above compound (2-a) and 29 mg of the above compound (3-a) were used as the near infrared light absorbable dye compositions, and the near infrared light absorbable filter was obtained in the same way as in Example 1. The content ratio of the compound (1-a), the compound (2-a) and the compound (3-a) in this near infrared light absorbable filter is the same as in the above use ratio because no exchange reaction did not take place.

This near infrared light absorbable filter has the transmittance of 20% or less at 825 nm, 880 nm and 980 nm, and thus effectively shields the light emitted from the PDP main body. The adhesion strength measured in the same way as in Example 1 was 850 g/25 mm width.

### Example 3

A near infrared light absorbable dye-containing pressure sensitive adhesive was prepared in the same way as in Example 1, except that 5 mg of the above compound (1-a), 52 mg of the above compound (2-a) and 18 mg of the above compound (3-a) were used as the near infrared light absorbable dye compositions, and the near infrared light absorbable filter was obtained in the same way as in Example 1. The content ratio of the compound (1-a), the compound (2-a) and the compound (3-a) in this near infrared light absorbable filter is the same as in the above use ratio because no exchange reaction did not take place.

This near infrared light absorbable filter has the transmittance of 20% or less at 825 nm, 880 nm and 980 nm, and thus effectively shields the light emitted from the PDP main body.

### Example 4

A near infrared light absorbable dye-containing pressure sensitive adhesive was prepared in the same way as in Example 1, except that 44 mg of the above compound (1-a), 6 mg of the above compound (2-a) and 25 mg of the above compound (3-a) were used as the near infrared light absorbable dye compositions, and the near infrared light absorbable filter was obtained in the same way as in Example 1. The content ratio of the compound (1-a), the compound (2-a) and the compound (3-a) in this near infrared light absorbable filter is the same as in the above use ratio because no exchange reaction did not take place.

This near infrared light absorbable filter has the transmittance of 20% or less at 825 nm, 880 nm and 980 nm, and thus effectively shields the light emitted from the PDP main body.

### <Evaluation Results>

Evaluation results of the near infrared light absorbable filters in Examples 1 to 4 are shown in Table 1.

TABLE 1

| | | | | Wet heat | | | Heat | | Heat |
|---|---|---|---|---|---|---|---|---|---|
| | | Evaluated | Light | resistance | | Wet heat | resistance | | resistance |
| | Aging | wavelength | resistance | test 1 | | resistance | test 1 | | test 2 |
| No | test | (nm) | test | 250 hr | 500 hr | test 2 | 250 hr | 500 hr | 250 hr |
| Example 1 | B | 825 | A | A | A | B | A | A | A |
| | | 880 | A | A | A | | A | A | A |
| | | 980 | A | A | A | | A | A | A |
| Example 2 | B | 825 | A | A | A | B | A | A | A |
| | | 880 | A | A | A | | A | A | A |
| | | 980 | A | A | A | | A | A | A |
| Example 3 | C | 825 | A | A | A | C | A | A | A |
| | | 880 | B | A | A | | B | B | B |
| | | 980 | C | B | C | | B | C | C |
| Example 4 | B | 825 | A | A | A | C | A | A | A |
| | | 880 | A | A | A | | A | A | A |
| | | 980 | B | B | B | | B | B | B |

The near infrared light absorbable filters in Examples 1 to 4 were excellent in any of the aging test, the light resistance test, the wet heat resistance tests and the heat resistance tests. Even if the evaluation is C, the filter can be sufficiently used. The filter having the particular composition was particularly excellent in them.

### Example 5

25 mg Of the above compound (1-a) and 75 mg of the above compound (2-a) were added to 33 g of toluene, and stirred at 80° C. for 6 hours to obtain a solution in which a near infrared light absorbable composition containing the compound (1-a), the compound (2-a) and the compound (3-a) had been dissolved. The content ratio of them was obtained by the following method using a high performance liquid chromatography, the content ratio of the compounds in the near infrared light absorbable composition solution was 5 mg of the compound (1-a), 72 mg of the compound (2-a) and 23 mg of the compound (3-a).

### <Method for Measuring Content Ratio>

A certain amount of the solution of the above compounds in toluene was weighed, placed in a measuring flask, diluted with tetrahydrofuran and measured at a wavelength of 254 nm using the high performance liquid chromatography. Standard curves were made using the compounds (1-a), (2-a) and (3-a) as standard products. Then, the content was calculated from a peak area on each chromatogram.

Using the resulting solution in which the near infrared light absorbable composition was dissolved, a near infrared light absorbable filter was formed in the same way as in Example 1, and absorbance (spectrum) at 800 to 1000 nm was measured, and evaluated by the following criteria. The results are shown in Table 3.

### <Evaluation Criteria>

A (800 to 1000): The extremely good absorbance was observed at an entire wavelength region of 800 to 1000 nm.

B (800 to 1000): The almost good absorbance was observed at the entire wavelength region of 800 to 1000 nm.

C (800 to 900): The absorbance at the wavelength region of 900 to 1000 nm was slightly small but the sufficient absorbance at the wavelength region of 800 to 900 nm was observed.

C (900 to 1000): The absorbance at the wavelength region of 800 to 900 nm was slightly small but the sufficient absorbance at the wavelength region of 900 to 1000 nm was observed.

### Examples 6 to 11

A solution in which a near infrared light absorbable composition containing the compound (1-a), the compound (2-a) and the compound (3-a) had been dissolved was obtained in the same way as in Example 5, except that the compound (1-a) and the compound (2-a) in feed amounts described in Table 2 were added to the toluene.

The content ratio of the respective compounds in the near infrared light absorbable composition solution was obtained in the same way as in Example 5. The results are collectively shown in Table 2.

A near infrared light absorbable filter was formed in the same way as in Example 5, the absorbance at 800 to 1000 nm was measured and evaluated similarly. The results are collectively shown in Table 3.

TABLE 2

| | | | Content of component in near | | |
|---|---|---|---|---|---|
| | | | infrared light absorbable | | |
| | | | composition solution (mg) | | |
| | Fed amount (mg) | | Com- | Com- | Com- |
| | Compound | Compound | pound | pound | pound |
| No | (1-a) | (2-a) | (1-a) | (2-a) | (3-a) |
| Example 5 | 25 | 75 | 5 | 72 | 23 |
| Example 6 | 33 | 66 | 8 | 63 | 28 |
| Example 7 | 50 | 50 | 21 | 39 | 40 |
| Example 8 | 55 | 45 | 27 | 33 | 40 |
| Example 9 | 62.4 | 37.6 | 37 | 22 | 41 |
| Example 10 | 67 | 33 | 45 | 16 | 39 |
| Example 11 | 75 | 25 | 58 | 8 | 34 |

TABLE 3

| | Absorption intensity |
|---|---|
| No | (spectrum) at 800 to 1000 nm |
| Example 5 | C (900 to 1000) |
| Example 6 | B (800 to 1000) |
| Example 7 | A (800 to 1000) |
| Example 8 | A (800 to 1000) |
| Example 9 | A (800 to 1000) |
| Example 10 | A (800 to 1000) |
| Example 11 | B (800 to 1000) |

The transmittance of these near infrared light absorbable filters was sufficiently low throughout the entire region of the near infrared wavelength and these filters efficiently absorbed the near infrared light. They also had the high transmittance of the visible light and were excellent in light resistance, heat resistance, wet heat resistance and durability.

### Example 12

In place of the compounds used in Example 5, 50 mg of a compound (1-b) and 50 mg of a compound (2-b) shown below were added (fed) in 33 g of toluene and stirred at 60° C. for 8 hours to obtain a solution in which a near infrared light absorbable dye composition containing the compound (1-b), the compound (2-b) and a compound (3-b) had been dissolved. A near infrared light absorbable filter obtained from this solution in the same way as in Example 5 showed the extremely good absorbance throughout the wavelength range of 800 to 1000 nm.

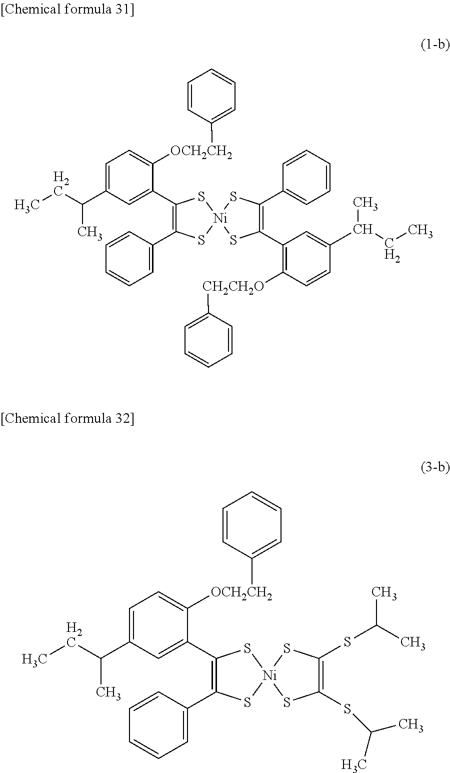

### Comparative Example 1

Powder of the compound (1-a) was dissolved in toluene, and the absorbance of the compound (1-a) was measured in a cell having the length of 1 cm using UV-3600 supplied from Shimadzu Corporation. The result is shown in FIG. 1. As can be seen from FIG. 1, the absorbance at 900 to 1100 nm in the compound (1-a) is insufficient and this compound can not be used alone.

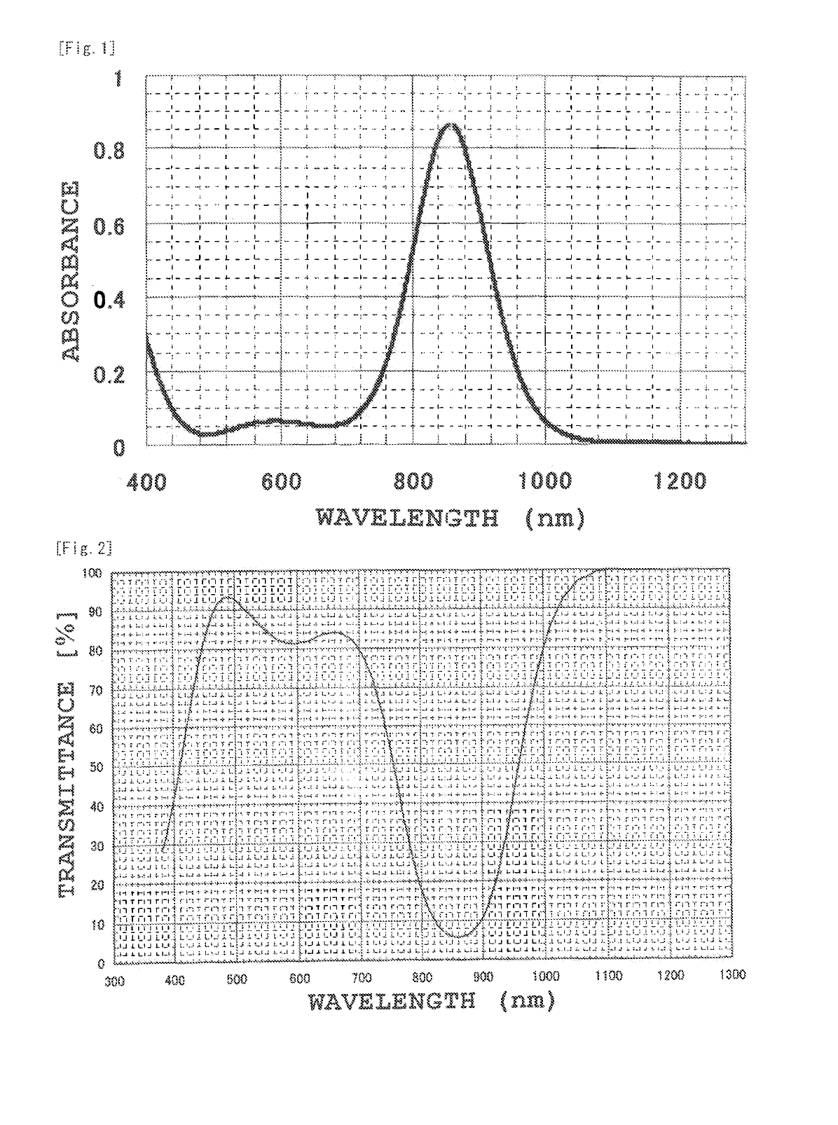

Using 50 mg of the compound (1-a), a near infrared light absorbable dye-containing pressure sensitive adhesive was prepared in the same way as in Example 1, and a near infrared light absorbable filter was obtained in the same way as in Example 1. The transmittance of this near infrared light absorbable filter was measured using UV-3150 supplied from Shimadzu Corporation. The result of measurement is shown in FIG. 2. As can be seen from FIG. 2, in the near infrared light absorbable filter using the compound (1-a), the absorbance at 900 to 1100 nm is insufficient and this can not be used alone.

### Comparative Example 2

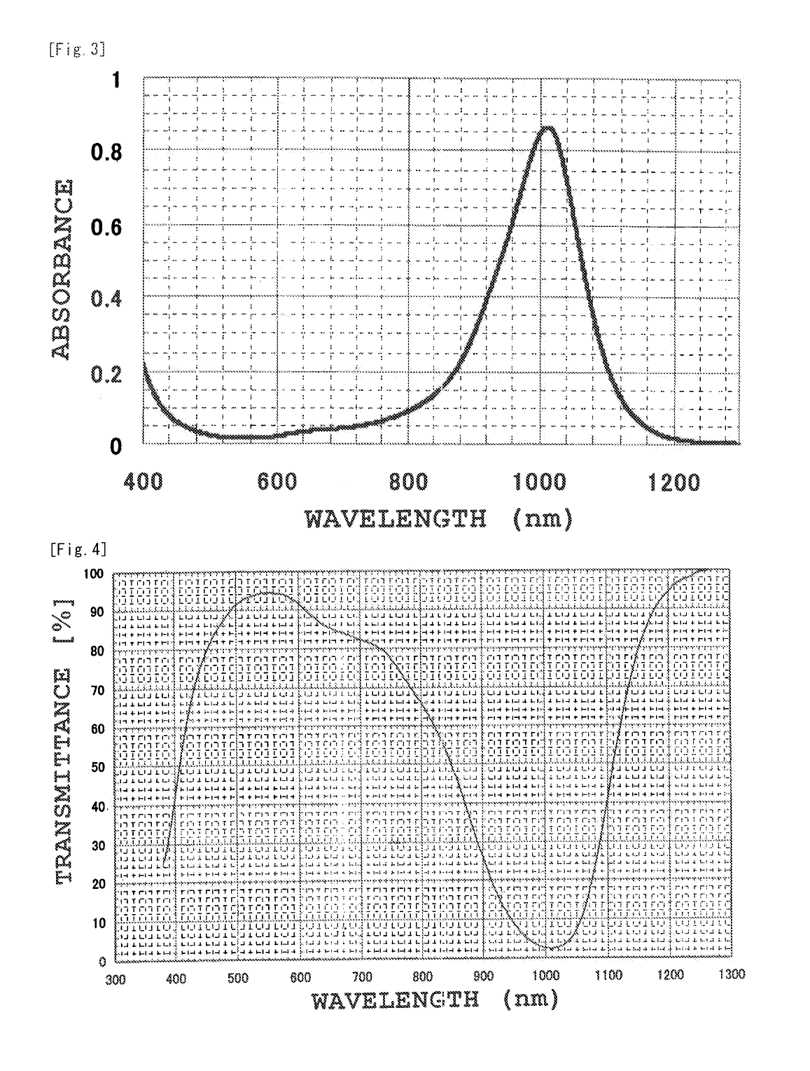

The absorbance of the compound (2-a) was measured in the same way as in Comparative Example 1. The result is shown in FIG. 3. As can be seen from FIG. 3, the absorbance at 800 to 900 nm is insufficient in the compound (2-a) and this compound can not be used alone.

Using 75 mg of the compound (2-a), a near infrared light absorbable filter was obtained in the same way as in Example 1. The transmittance of this near infrared light absorbable filter was measured in the same way as in Comparative Example 1. The result of measurement is shown in FIG. 4. As can be seen from FIG. 4, in the near infrared light absorbable filter using the compound (2-a), the absorbance at 800 to 900 nm is insufficient and this can not be used alone.

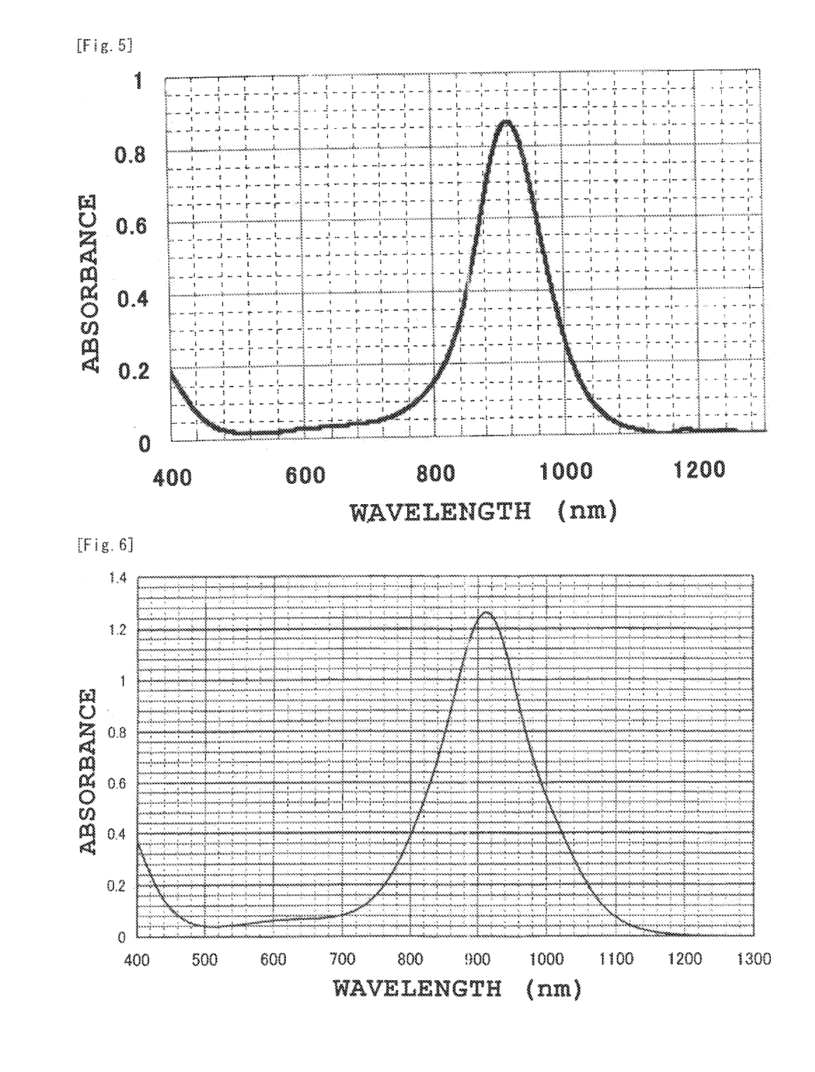

The absorbance of the compound (3-a) was measured in the same way as in Comparative Example 1. The result is shown in FIG. 5. As can be seen from FIG. 5, the absorbance at 800 to 1100 nm was almost sufficient. However, in order to synthesize the compound (3-a) alone and produce a near infrared light absorbable filter and a near infrared light absorbable dye-containing pressure sensitive adhesive containing it, the synthesis and isolation of the compound (3-a) requires the high cost. Thus, the near infrared light absorbable filter containing the compound (3-a) alone was not practical.

### Example 13

The “near infrared light absorbable composition solution containing the compounds (1-a), (2-a) and (3-a) at the ratio described in Table 2” obtained in Example 10 was diluted with toluene, and its absorbance was measured in the same way as in Comparative Example 1. The result is shown in FIG. 6. As can be seen from FIG. 6, the absorbance is significantly high throughout the wavelength at 800 to 1100 nm. Because of being prepared only by stirring at 80° C. for 6 hours after mixing the compound (1-a) and the compound (2-a), this is excellent in cost.

### INDUSTRIAL APPLICABILITY

The near infrared light absorbable filter and the near infrared light absorbable dye-containing pressure sensitive adhesive using the near infrared light absorbable composition of the present invention are excellent in light resistance, heat resistance and wet heat resistance, cut off the near infrared light in the wide range, have the high visible light transmittance, are advantageous in production cost and have an excellent shielding function for the near infrared light, and thus, are widely utilized for the electronic devices such as PDP.

The present application is based on JP 2006-292716-A which is Japanese patent application filed on Oct. 27, 2006, all contents of this application are cited here and incorporated as the disclosure of the specification of the present invention.

1-12. (canceled)

13. A near infrared light absorbable dye composition comprising a compound represented the following general formula (1), a compound represented the following general formula (2) and a compound represented by the following general formula (3): 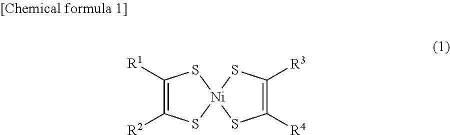
wherein R¹, R², R³ and R⁴ each independently represent an organic group which has a carbon atom at a binding position in the general formula (1) and may have a substituent, or a hydrogen atom, and wherein, R¹ and R², and R³ and R⁴ may together form a ring; 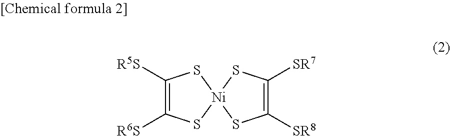
wherein R⁵, R⁶, R⁷ and R⁸ each independently represent an aliphatic hydrocarbon group which may have a substituent or an aryl group which may have a substituent, and wherein R⁵ and R⁶, and R⁷ and R⁸ may together form a ring; and XR′R″R′″R″″ may be coordinated to the general formula (2) to take a salt type (wherein, X represents a group-15 atom and R′, R″, R′″ and R″″ each independently represent an aliphatic hydrocarbon group which may have a substituent or an aryl group which may have a substituent; 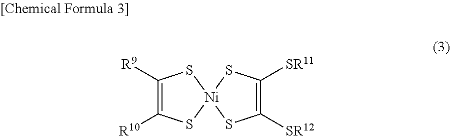
wherein R⁹ and R¹⁰ represent R¹ and R² or represent R³ and R⁴ in the general formula (1), and R¹¹ and R¹² represent R⁵ and R⁶ or represent R⁷ and R⁸ in the general formula (2), respectively.

14. The near infrared light absorbable dye composition according to claim 13, wherein the compound represented by the above general formula (3) is synthesized by mixing the compound represented by the above general formula (1) and the compound represented by the above general formula (2) in a solution.

15. The near infrared light absorbable dye composition according to claim 13, wherein either one of the compound represented by the above general formula (I) or the compound represented by the above general formula (2) has its maximum absorption wavelength at 750 to 950 nm and the other compound has its maximum absorption wavelength at 900 to 1200 nm.

16. The near infrared light absorbable dye composition according to claim 13, wherein the compound represented by the above general formula (3) comprises 20% by mass or more based on the entire near infrared light absorbable dye composition.

17. The near infrared light absorbable dye composition according to claim 13, comprising 3 to 60 parts by mass of the compound represented by the above general formula (1), 7 to 80 parts by mass of the compound represented by the general formula (2) and 20 to 80 parts by mass of the compound represented by the general formula (3).

18. A near infrared light absorbable dye composition solution, wherein the near infrared light absorbable dye composition solution is prepared by mixing a solution of a compound represented by the following general formula (1) and a solution of a compound represented by the following general formula (2) and contains the compounds represented by the following general formulae (1), (2) and (3): 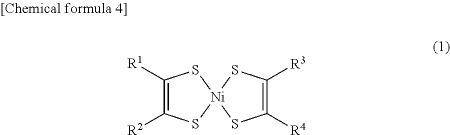
wherein R¹, R², R³ and R⁴ each independently represent an organic group which has a carbon atom at a binding position in the general formula (1) and may have a substituent, or a hydrogen atom, and wherein, R¹ and R², and R³ and R⁴ may together form a ring; 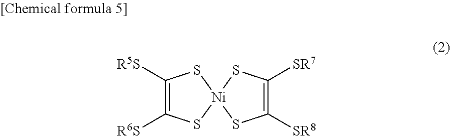
wherein R⁵, R⁶, R⁷ and R⁸ each independently represent an aliphatic hydrocarbon group which may have a substituent or an aryl group which may have a substituent, and here R⁵ and R⁶, and R⁷ and R⁸ may together form a ring; and XR′R″R′″R″″ may be coordinated to the general formula (2) to take a salt type (wherein, X represents a group-15 atom and R′, R″, R′″ and R″″ each independently represent an aliphatic hydrocarbon group which may have a substituent or an aryl group which may have a substituent; 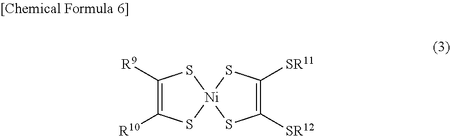
wherein R⁹ and R¹⁰ represent R¹ and R² or represent R³ and R⁴ in the general formula (1), and R¹¹ and R¹² represent R⁵ and R⁶ or represent R⁷ and R⁸ in the general formula (2), respectively.

19. The near infrared light absorbable dye composition solution according to claim 18, wherein either one of the compound represented by the above general formula (1) or the compound represented by the above general formula (2) has its maximum absorption wavelength at 750 to 950 nm and the other compound has its maximum absorption wavelength at 900 to 1200 nm.

20. The near infrared light absorbable dye composition solution according to claim 18, wherein the compound represented by the above general formula (3) comprises 20% by mass or more based on the entire near infrared light absorbable dye composition.

21. The near infrared light absorbable dye composition solution according to claim 18 comprising 3 to 60 parts by mass of the compound represented by the above general formula (1), 7 to 80 parts by mass of the compound represented by the general formula (2) and 20 to 80 parts by mass of the compound represented by the general formula (3).

22. The near infrared light absorbable dye composition solution according to claim 18, wherein the compound represented by the above general formula (1) and the compound represented by the above general formula (2) are mixed in a range of a mass ratio of 1:4 to 4:1 in the solution.

23. A near infrared light absorbable dye-containing pressure sensitive adhesive comprising the near infrared light absorbable dye composition according to claim 13.

24. A near infrared light absorbable dye-containing pressure sensitive adhesive produced using the near infrared light absorbable dye composition solution according to claim 18.

25. The near infrared light absorbable dye-containing pressure sensitive adhesive according to claim 23, wherein the pressure sensitive adhesive contains a (meth)acrylic polymer.

26. The near infrared light absorbable dye-containing pressure sensitive adhesive according to claim 24, wherein the pressure sensitive adhesive contains a (meth)acrylic polymer.

27. A near infrared light absorbable filter comprising the near infrared light absorbable dye composition according to claim 13.

28. A near infrared light absorbable filter produced using the near infrared light absorbable dye composition solution according to claim 18.

29. A near infrared light absorbable filter produced using the near infrared light absorbable dye-containing pressure sensitive adhesive according to claim 23.

30. A near infrared light absorbable filter produced using the near infrared light absorbable dye-containing pressure sensitive adhesive according to claim 24.

31. A filter for an electronic display comprising the near infrared light absorbable dye composition according to claim 13.

32. A filter for an electronic display produced using the near infrared light absorbable dye composition solution according to claim 18.
